(19) United States
(12) Patent Application Publication
(10) Pub. No.: US 2012/0151223 A1
(43) Pub. Date: Jun. 14, 2012

(54) METHOD FOR SECURING A COMPUTING DEVICE WITH A TRUSTED PLATFORM MODULE-TPM

(76) Inventors: Ricardo Nuno DE PINHO COELHO CONDE MARQUES, Azambuja (PT); Paulo Jorge ESTEVES VERISSIMO, Estoril (PT)

(21) Appl. No.: 13/237,886

(22) Filed: Sep. 20, 2011

Related U.S. Application Data
(60) Provisional application No. 61/384,638, filed on Sep. 20, 2010.

(51) Int. Cl. G06F 21/24

(52) U.S. Cl. 713/193

(57) ABSTRACT

Methods, systems and computer program products for securing a computing device with data storage, power-on firmware—BIOS, geolocation and mobile data module—GPS/GSM, and a Trusted Platform Module—TPM, including establishing a shared-secret between the BIOS and the TPM, requesting the TPM to generate suitable encryption keys, namely for encrypting the data storage, supplying the user of the computing device suitable keys for external storage, calculating a hash-based message authentication codes over the BIOS, MBR, unique ID of the TPM, unique ID of the GPS/GSM module and unique ID of the BIOS; using user provided password and/or token device; using mobile data messages to secure the device if misplaced.

### CROSS-REFERENCE TO RELATED APPLICATIONS

This application is a non-provisional U.S. patent application and claims priority under 35 U.S.C. §119 to U.S. Provisional Application No. 61/384,638 filed on Sep. 20, 2010, the entire disclosure of which is hereby incorporated herein by reference.

### BACKGROUND

1. Field

### 1. Introduction

How much is the information inside a computer worth? In general, this question is very hard to answer. It could be worth anything from a few cents up to several thousand Euros, depending on the amount and type of information. However, most people have never really thought about the value of the information stored in their computers, and most will never do, unless they find themselves deprived of that information or when that information is misused by other people, i.e., when it is usually too late.

Since computers are now accessible to most citizens in developed economies, and the world is becoming more dependent on digital media and workflows, it is only natural to assume computers today will store much more digital information than they used to in the past. Unfortunately, this also means that the more computers are around, the more likely it is for some of them to be lost or stolen.

Inside a computer one usually stores files that are used on a regular basis, and also files that were once used regularly but no longer are, which one does not want to lose. If it is a personal computer, it is also likely that one will use it to store one's digital photographs, music and videos. A corporate computer is likely to have files with intellectual property that one's institution would not want to share with the market or its competitors, and quite possibly files relating to or containing customer data.

As the computer became a tool for everyday use, it also became really convenient for people to use it to store all those kinds of data, especially data people do not want to forget. Thus, it is not hard to understand that any computer will most likely have files with identity elements. These identity elements may include email addresses, phone numbers, usernames or passwords for several kinds of services, credit card numbers used for online shopping or as a backup reference in case the card is lost, or social security numbers, among others.

It seems clear that the possibility of having the equipment misplaced is too real to be ignored, so it is time to face this problem using “when it happens” methods and techniques, instead of the “if it happens” ones commonly used nowadays.

While file-system solutions exist that protect one's data from unauthorized users, including access control and encryption mechanisms, and backup solutions allow one to reduce the amount of information lost forever if a computer is lost or stolen, they do not seem to be widely used, or at least as widely as it would be desirable [4]. Besides protecting one's data, and some of those measures will only protect the data as long as the person stealing the computer is not tech-savvy, it would be interesting to be able to recover the equipment and the data when the computer is misplaced. For that, some solutions exist that promise to recover a computer once it connects to the Internet.

The concept of recovering a computer once it connects to the Internet might seem interesting, but it has some disadvantages. It requires that the computer is turned on and sometimes even requires that the user is able to login into the operating system, so that the computer can use the Internet connection to contact its owner or a server and say where it is. This means that the illegal owner of the computer will probably need to use some user's password, if any login password is required at all, and this means that data compromise could be the next step.

The envisioned approach follows a preventive-reactive approach, ensuring the protection of the data inside the computer, while at the same time allowing its legitimate owner to recover it if required.

While large criminal organizations exist, which will do anything they can and use whatever means available to protect a computer that they have stolen, if the economical benefit is worth the effort, they are not the main target of the present approach. Instead, the present approach is aimed at other kinds of felonious people and acts. The data confidentiality approach works against most kinds of criminals, including the ones that steal equipment from inside an organization with the intent of industrial espionage or other kinds of misuse. On the other hand, the recoverability approach can only target petty thieves that rob a car or a house and steal computers with the main purpose of quick profit, perhaps to engage in other criminal activities, and criminals with limited knowledge of hardware. These should account for the vast majority of stolen equipment, and the statistical data at the beginning of this section, gathered from [2], do not seem to prove otherwise.

2. Background Art

### 2. Brief Technology Overview

The approach in this document relies on already existing technology, so it is important that the reader has a basic knowledge about it. A brief introduction to some of the technology behind this work is provided, but it does not intend to advance thorough details or include comprehensive descriptions of how the technology operates, which would enlarge this work and make it harder to read. Instead, only the relevant information for understanding the present approach is included, and the reader is referred to other works, where the concepts are explained in depth.

One of the basis behind this work is that the technology and the tools behind this present approach can be extended in order to provide some additional functionality, as described throughout this document, at a reasonable price, and without too much development effort. Another basis is that the kind of technology used in this present approach will be included in future computers, with a slight difference on the retail price, but that the consumer will be willing to pay the extra tens or hundreds of Euros for the additional security of their equipment. As the deployment of such solutions increases, the manufacturing costs will decrease, and it should be possible to add them to entry-level systems at almost no extra cost.

This document starts by presenting the TPM, used to ensure confidentiality of the data, and will then proceed with the other two cornerstones of this present approach: GSM and GPS. GPS and GSM ensure that the computer is able respectively, to know, and tell, its whereabouts, once the legitimate owner asks, but without requiring it to be connected to the Internet as we know it. An overview of the concepts behind file-system security is provided, and, in the end, a cost estimation for the extra technology is performed.

2.1 TPM

A Trusted Platform Module (TPM) is a small micro-controller, usually affixed to a computer's motherboard, that is able to store keys, passwords and digital certificates [8], which can potentially be used in any computing device that requires such functionality. Since the information is stored inside a silicon chip, it is made more secure from physical attacks and external theft by software. It ensures the secure execution of applications that demand it, such as secure e-mail or secure web-browsing. It can perform authentication, data encryption and signatures, and it can be configured to deny access to data if the booting sequence is not the expected. All keys stored inside a TPM are never exposed to the outside.

In order to perform its functionality, a TPM includes [9]:
I/O port, which is used to send data to and receive data from the TPM;
cryptographic co-processor, which implements cryptographic operations within the TPM, including asymmetric key generation (using RSA), asymmetric encryption/decryption (using RSA), hashing (SHA-1) and random number generation;
key generation component, which creates RSA key pairs and symmetric keys;
HMAC engine, which provides the TPM with two kinds of proof:
   knowledge of the Authentication and Authorisation Data (AuthData), i.e., the shared secret between the TPM and any other component that uses it, which ensures that the latter is authenticated and authorised to use the former;
   the request arriving at the TPM is authorised and maintained its integrity while it was in transit;
Random number generator, which is the source of randomness of the TPM, used for nonces, keys and randomness in signatures;
SHA-1 engine, which is a trusted implementation of a hash algorithm and provides the SHA-1 hash capability;
Power detection component, which ensures that the TPM is informed about all power state changes occurring in the hosting platform;
Opt-in component, which provides functionality to turn on/off, enable/disable, activate/deactivate the TPM
Execution engine, which executes the commands received from the I/O port;
Non-volatile memory component, which is used to store persistent identity and TPM state;
Sixteen 160-bit long platform configuration registers (PCR) that can be used for discrete integrity measurements, which is achieved through a cryptographic hash based on the concatenation of the previous value and new value, thus ensuring ordering and one-way-ness;
2048-bit key pair called the endorsement key (EK), which is generated before the end customer receives the platform, typically by the TPM's manufacturer, and can be used to provide evidence of the validity of the TPM.

The TPM provides an interface that is used by other components in the system to invoke the TPM methods. It is called TPM API and requires that the calling components provide some AuthData, which is a secret shared between the TPM and the component, and proves that the component is both authenticated and authorised to use the TPM. AuthData management is provided by the Authorisation-Data Insertion Protocol (ADIP) and by the Authorisation-Data Change Protocol (ADCP) [9], which are secure protocols executed between the TPM and any component that needs to use the TPM's services.

A TPM owner password, which is defined during the initialisation process of the TPM and stored inside the TPM, allows its owner to perform operations on the TPM such as enabling, disabling and resetting it. In order to disable or reset a TPM, it is required that the user provides the TPM owner password, as proof of ownership. This input is compared with the key stored inside the TPM and only then is the operation allowed. Resetting the TPM will restore it to factory default settings and all keys stored inside the TPM will be deleted, except for the endorsement key. As a consequence, all data protected only by those keys will become inaccessible. No cryptographic key ever leaves the TPM, once its ownership has been taken, and is visible outside it. Depending on the TPM's manufacturer, it is possible to define the maximum number of attempts to enter an incorrect TPM owner password before the TPM completely blocks the access to the computer.

Recently, TPM devices have been proposed or used for trusted monotonic counters [10], secure clocks [11], software protection [12], secure bootstrap architectures [13], mutual attestation for web services [14], and Byzantine fault tolerance [15], among others. TPM devices are currently produced by Atmel, Broadcom, Infineon, Sinosun, STMicroelectronics, and Winbond, and are becoming more frequent in desktop, notebook and tablet PCs from Apple, Dell, Fujitsu, Gateway, HP, Intel, Lenovo, Toshiba and others.

2.2 GSM, GPRS, EDGE, UMTS and HSPA

Global System for Mobile (GSM) communications is the most popular standard for mobile phones. It is estimated that over 85% of the global mobile market uses this standard. This means around three thousand million, or three billion in US terms, people spread across more than two hundred countries and territories [16], considering one service per customer. GSM systems provide a number of useful features, such as encryption to make phone calls more secure, data networking, group III facsimile services, Short Message Service (SMS) for text messages and paging, call forwarding, caller ID, call waiting, and multi-party conferencing [17, 18].

In a GSM network, each device connects to the network by looking for cells in the immediate vicinity. These cells are organised in a grid-like layout, with each cell's coverage ranging from a few hundred meters to several kilometres. It is thus possible, and likely, that one mobile device is within the range of several cells at the same time.

The Subscriber Identity Module (SIM) card in GSM devices, which identifies the subscriber, is what controls if a user is allowed to use the network or not. When the device is turned on, it will contact the nearest base station, whose cell covers the location of the GSM device, and exchange some information contained in the SIM so that the cell network validates if the device is authorised to use it or not. This process is known as authentication and key generation, and results in the definition of an encrypted channel between the device and the base station [19].

The mobile device authenticates before the network but the network does not authenticate before the mobile device, thus making the mobile device vulnerable to impersonation attacks, in which an attacker pretends to be a GSM network provider. Whenever a GSM device requests a connection to a base station that does not belong to the same network as the SIM, this process is further enhanced with the cell's base station contacting the device's home network, as retrieved from the SIM, and verifying if that given device is allowed to use the host network. If the device is allowed to use that network, the connection to the network is established and the device is said to be roaming.

When a mobile-mobile phone call is placed, the originating device will contact the nearest base station of the cells in range, and the base station in that cell will communicate with the base stations in other cells, until the signal reaches the base station of the cell where the destination device is located, which will forward the call to the device, and the destination device will either take or reject the call. On fixed line-mobile or mobile-fixed line calls, the base stations of the cell network will connect to the Public Switched Telephone Network (PSTN), in order to appropriately route the call. If the destination accepts the call, then the call is established between the initiator and the terminator devices.

GSM voice calls are encrypted using the A5 family of algorithms, and customers rely on these algorithms for their privacy. A5/0 provides no encryption, A5/1 is the encryption algorithm, and A5/2 is the “export-friendly” weakened algorithm [19]. There is a new algorithm, called A5/3, which is based on the UMTS/WCDMA algorithm Kasumi [19, 20], and it is believed to be more secure as it uses a block-cipher with 128-bit keys for encryption and integrity checks. Even though the A5 algorithms are part of the GSM specification, they were not made public. Nevertheless, several researchers have proven that these algorithms are breakable in real-time and at a reasonably low cost [21, 22, 23, 24], thus allowing a malicious user to eavesdrop on conversations involving mobile subscribers. However, in order to do so, the malicious user would have to be the bearer of the appropriate tools and knowledge, which are not really easy to obtain by a common individual.

GSM devices operate in the 900 MHz (890-960 MHz) and 1800 MHz (1710-1880 MHz) bands in Europe, Middle East, Asia, Africa and some South America countries, and the 850 MHz (824-894 MHz) and 1900 MHz (1850-1990 MHz) bands in the United States and Canada. Some devices can operate on all bands, with the equipment switching between the available bands and frequencies in order to use to the one with the best signal reception [25].

General Packet Radio Service (GPRS) is a packet-switched technology, based on GSM, which allows a mobile device to use the Internet Protocol (IP) to send and receive data. Such devices can execute several applications that depend on network connectivity, such as email, web browsing, file transfer, and location-aware applications, at theoretical speeds of up to 171.2 kbps [26]. It is a step towards 3rd Generation Networks (3G) and is usually referred to as 2.5G.

Even though GPRS is based on GSM, it uses different kinds of authentication and encryption mechanisms [27], with all the GPRS Encryption Algorithms (GEA) being kept secret. GEA3, which is used for encryption of any data flowing between the device and the cell network, is also based on Kasumi [20]. Most attacks against GPRS are targeted at the GPRS backbone, at the interface between GPRS networks and at the interface between GPRS networks and the Internet [28]. Nevertheless, these attacks require extensive equipment and knowledge, not easily obtainable by common individuals.

Enhanced Data Rates for GSM Evolution (EDGE) [29] and Universal Mobile Telecommunication System (UMTS) [30] are both 3G network technologies that enable operators to offer multimedia and other IP-based services at speeds of up to 384 kbps download (EDGE), and approximately 2 Mbps download with 384 kbps upload (UMTS). High Speed Packet Access (HSPA), and its two variants High Speed Downlink Packet Access (HSPDA) and High Speed Uplink Packet Access (HSUPA), are enhancements to UMTS, sometimes referred to as 3.5G, and can push that value up to approximately 10 Mbps in the downlink direction (HSDPA) and up to approximately 2 Mbps in the uplink direction (HSUPA).

In addition to the frequency bands used by GSM, UMTS devices can also operate in the 1700 MHz (1710-1770 MHz) and 2100 MHz (2110-2170 MHz) bands [31].

As of May 2008 [32]:
three hundred and thirteen EDGE networks had been commercially launched in one hundred and forty-seven countries, compared to two hundred and twenty-three launches in one hundred and thirteen countries in May 2007;
there had been two hundred and thirty-four HSPA network commitments in ninety-six countries, including one hundred and ninety-eight commercial launches in eighty-six countries;
90% of commercial Wideband Code Division Multiple Access (WCDMA) networks, i.e., UMTS networks, had launched HSPA;
commercial HSPA-enabled broadband services had been launched in all twenty-seven countries of the European Union. UMTS was built with security in mind from the start, as opposed to GSM. As a result, it prevents some of the problems that were associated with GSM networks, by providing mechanisms to mitigate attacks which were not perceived to be feasible in 2G systems. The attacks addressed by 3G networks include several forms of denial of service, identity catching, i.e., obtaining the identity of the user, impersonation of the network or of the user and eavesdropping attacks. Even though great emphasis has been put on communications node security, inter- and intra-network security, SIM security, and on authentication and cryptography algorithms [33], researchers have already been able to perform man-in-the-middle attacks against UMTS [34]. Just like in GSM and GPRS, the tools and knowledge required for these attacks are hard to obtain by common individuals.

Some hundreds of personally-conducted tests, carried across different cities in Portugal, Spain and Germany, have shown that a regular GSM cell phone requires at most sixty seconds to register with the cell network, if coverage exists in the area and the device is authorised to use that network, either as its home network or as a roaming network. In 99% of the cases, this interval was around or below thirty seconds. Fewer tests conducted with 3G equipment have revealed approximately the same amounts of time for the equipment to register with the network. Additional tests have shown that any pending messages are delivered in the thirty seconds interval after the device registers with the network, over 98% of the times.

Even though GSM and its derivatives are usually associated with mobile phones, several vendors are already including HSPA modules with their computers [35], and these only require that a SIM module is added and activated by its cellular network operator. These modules can operate as modems and connect the computer to the Internet over the cellular network, or enable the computer to make and receive phone calls without requiring an additional cellular phone.

2.3 Positioning and Location Services

It is possible for an electronic device to receive information and calculate its position on the Earth's surface, and this can be done using different types of technology. It is also possible for an electronic device to extend that functionality and report its position, so that it can be used for tracking. This section presents some details about that technology.

2.3.1 GPS, GLONASS, Galileo, CNSS and IRNSS

The Global Positioning System (GPS), or NAVSTAR GPS to be more precise, is a satellite navigation system with global coverage that provides information regarding latitude, longitude and altitude to electronic devices, allowing them to calculate their location. A constellation of at least twenty-four and up to thirty satellites, in low earth orbit, work together and provide navigation data to the user device, using line of sight radio communications, in which the end-user device is a passive listener in the 1575.42 MHz frequency. This data, collected from at least four satellites, allows the end-user device to perform some triangulations and calculate its position, to within a few meters, as well as its velocity. In addition, this data provides devices with a reliable and precise time source, since the ground control network regularly updates the satellite clock corrections, based on the values of atomic clocks [36].

Even though GPS was initially developed by the United States Department of Defense and is managed by the United States Air Force, the GPS Standard Positioning Service is available to civil users worldwide for peaceful uses and free of direct user charges, providing an accuracy up to the order of ten meters, further increased to 1-5 m or even better if differential GPS is employed [37]. In differential GPS a reference receiver knows its exact position, and that information can be used by the user's receiver to determine “biases” in its pseudo-range measurements and thus provide better accuracy.

Global Navigation Satellite System (GLONASS) is an alternative to GPS, developed by the former Soviet Union and now managed by the Russian Space Forces, a division of the Russian government. The full constellation consists of twenty-four satellites in medium earth orbit, but will be expanded to thirty [38]. Only sixteen are deployed and four of these were in maintenance as of 24 Jun. 2008 [39], thus it does not provide global coverage at this time [40]. The expected accuracy is within 50-70 m [41], but a receiver can combine GPS and GLONASS signals for better results.

Galileo, named after the Italian astronomer Galileo Galilei, is a planned global navigation system being developed by the European Union and the European Space Agency. It is “the first satellite positioning and navigation system specially designed for civil purposes” [42], and will consist of thirty satellites in intermediate circular orbit and provide better accuracy than GPS or GLONASS, up to the order of one meter. It will allow European nations to use an independent source of positioning information, in case of political conflicts, and it is expected to be operational by 2013 [42, 43].

Compass Navigation Satellite System (CNSS), or BeiDou 2 in its Chinese name, will be an independent positioning system and will provide navigation and positioning services for China and neighbouring countries, but it will eventually be extended towards a global coverage. It will consist of five geostationary earth orbit satellites and thirty medium earth orbit satellites, with an expected accuracy within ten meters [44].

Indian Regional Navigational Satellite System (IRNSS) intends to be an autonomous regional satellite navigation system and is being developed by the Indian Space Research Organisation. It will consist of seven satellites in geostationary orbit, and is expected to be functional by 2012 [45].

Since GPS is the only system among these that has global coverage and is fully functional nowadays, this document will consider it as the basis for location services. However, other global navigation systems can easily be integrated instead of GPS when they become available. GPS devices are commonly used to provide mapping and navigation information to people, cars, boats and airplanes.

Standalone GPS units are sold by Garmin, Magellan, Furuno, TomTom, Icom, Lowrance, Raymarine, DeLORME, Standard Horizon, Northstar and others, and go from completely portable units to ship-mounted ones. An Original Equipment Manufacturer (OEM) GPS receiver can be embedded into a small electronic chip, with less than 3 cm2, which means it can easily be shipped within consumer-grade devices, such as mobile phones or computers.

When OEM GPS units are included into a cell phone or computer, they usually do not include a GPS antenna, due to the space restrictions inside the equipment as in the circuit board of Apple's iPhone 3G [46], a smart phone that combines the functionality of a GSM/GPRS/EDGE/UMTS phone with a GPS receiver, and one can clearly identify the chip in charge of handling the GPS signal.

2.3.2 GSM-Based, Assisted GPS and GPS Tracking

Location Based Services (LBS) are services provided by GSM operators to their customers, allowing them to access services based on their location, which includes finding other people, locating resources, using location-sensitive services and even tracking their own location.

Location based services fall into one of three categories, depending on their flow: pull, push and tracking. A pull service is always initiated by the customer, for example by sending a special message to a given number. A push service is one in which the network regularly sends localized data to the receiver, after the customer has authorised the network to send it that information once, and that authorization will be used until the customer decides to stop receiving it. A tracking service is one in which a person or service asks for the location of a mobile terminal, which can be a vehicle, a person, etc. When a location request is issued by the network, the customer owning the receiver that is being located has to authorize it, unless the customer has explicitly initiated the request for a location based service, for example by sending a message to a given number requesting to receive the local weather forecast [47].

While these services are easy to implement for operators, and some already do [48] or are in the process of deploying them [49], the situation gets more complicated when several operators need to provide inter-working for customers who are currently roaming in another operator's network. However, just as it happened for Short Message Services, when inter-operator inter-working exists, it is likely that the offering of location-based services will increase. A typical city setup can provide accuracy of up to a few meters, whereas accuracy of up to a few tens of kilometres may be provided in rural scenarios, depending on the cell-grid layout. The location-based services' specification [47] states that the accuracy parameter should be specified by the entity requesting the location, and that the charging for such service should be dependent on the desired accuracy, among several other parameters.

Assisted GPS (A-GPS) is a system in which an external reference is used to help a GPS receiver perform the required computations, for position and location determination [50], in a much shorter interval. In modern mobile phones, this is achieved by retrieving the position and velocity of each satellite from an Assisted GPS server, which is done over the device's Internet connection (GPRS or 3G). After receiving this information, the device knows which satellites it must listen to in order to calculate its location, i.e., it will only listen to satellites that cover its current position, and where on Earth's orbit to find them. This reduces the amount of time, up to some tens of seconds, required before the GPS receiver is able to find and lock on a GPS signal, i.e., the Time To First Fix (TTFF).

By reducing the TTFF, a receiver is able to listen to any given satellite for a longer period of time, which increases the effective sensitivity and allows weaker signals to be used for calculations. At the same time, the additional information regarding the cell tower location, allows the receiver to start calculating the position without having to wait for the triangulation computations to complete.

The overall result of such approach is clear: location and position information that take less time to compute make location based services and applications more responsive and user-friendly, while at the same time providing mobile devices with GPS accuracy similar to that of dedicated GPS receivers. This enables a cell phone to recover maps from the Internet and use them for guidance or path finding, just as it is done by Apple's iPhone [46], Nokia's N96 [51], and others.

A GPS tracking unit uses GPS signals to periodically identify its location. This information can be stored inside the tracking unit itself or at a centralized server using an embedded modem in the unit, usually operating on GSM/GPRS. This functionality allows for a path to be revisited in the future, but also to keep up with the location of the unit in real-time. It can be used for fleet and vehicle tracking [52], but also for personal tracking [53], including in emergencies [54].

2.4 File-System Security

File-system security is a topic that cannot be taken easily. While non tech-savvy users do not even care about it, most naïve users believe that it can be achieved through user and group permissions, which might actually be true in some scenarios. However, security-aware users resort to hard disk encryption as the de facto way to protect their data. This section includes a brief explanation, advantages and disadvantages of each method.

2.4.1 User and Group Permissions

Some modern operating systems enforce data access control based on user or group permissions, also known as access control lists (ACL), and others on demanding that the user processes acquire a permit in order to access some data, or capabilities [55]. An ACL exists for every object in the system and contains a list of permissions that specify what each subject can and cannot do with that object. A capability associates a set of access rights to objects, and works as an unforgeable token of authority that any process must obtain before accessing the data. Permission verification is enforced by requiring the user to provide a login name into the system, which allows the user to be identified as a subject, and then any access to resources is checked against the permissions associated with that subject.

The New Technology File System (NTFS), designed for the Windows NT operating system, and used by Windows 2000/2003, Windows XP and Windows Vista [56], uses an ACL-based discretionary access control mechanism and each user is allowed to grant or revoke the authorization for other users or groups of users to access their objects. These permissions are usually inherited by child objects, i.e., files inside a folder. Superusers, or Administrators as they are called in Windows, are by default allowed to define permissions even for objects they do not own, but this can be prevented if the owner of the objects removes the permissions associated with the administrators from the ACL of the object.

Even though Windows stores the information about which users are able to access each file, this can easily be bypassed once you get access to the computer. For example, the Backup program, included by default in Windows installations, allows a user (with appropriate privileges, of course) to backup a set of files, even if they are marked private, and restore them removing some permissions information. Even more can be achieved by using a bootable Live Windows CD [57], which will provide the user with a Windows environment, with network support, a graphical user interface (GUI) and FAT/NTFS/CDFS file-system support, that can be used to reset the permissions on every file. Alternatively, if one gains physical access to the computer, one can just connect the disk to another machine where one has an administrator account and bypass the file-system access control list for the compromised disk.

UNIX-like file-systems, which include most Linux-based systems and Mac OS X systems, use a simplified form of ACL to manage file permissions. Each file contains permission information for the user, for the group and for the others, and these permissions can be changed using the chmod command, or via the GUI in some systems. The user is the owner of the object, while the group consists of the users in the same group as the owner (except the owner), and all other users are included in the others group [58]. User permissions take precedence over group ones. There are three types of permissions: read, write and execute. These permissions are not usually inherited by child objects, and they will deny access to the object if not set.

Just like in Windows, these permissions are easy to bypass once one gets access to the computer. A superuser, or root, can execute the chown command and obtain ownership of one or more files, can use chmod and change the file's permissions and can copy the files at will. This can also be done by using a live bootable CD or by connecting the disk to another machine where one is the superuser. In Mac OS X, this can also be achieved easily by using FireWire target disk mode, in which a Macintosh computer with a FireWire port can be used as an external hard disk connected to another computer, unless “Open Firmware Password”, in PowerPC based Macs, or “Extensible Firmware Interface Password”, in Intel-based Macs, has been enabled, which by default has not [59]. The “Open Firmware Password” or “Extensible Firmware Interface Password” is requested every time a Macintosh computer is started, and it works just like the BIOS password for starting a PC.

From the previous paragraphs, it is clear that file-system security based on user and group permissions might be enough for everyday usage, but it is insufficient to prevent malicious users from accessing the data if they obtain physical access to the computer. Therefore, for complete confidentiality, one has to resort to cryptography.

2.4.2 Hard Disk Encryption

Encryption is the most secure way of protecting data in storage media. It is currently the subject of study of the IEEE P1619 Security in Storage Working Group (SISWG) [60], which is working on standards related to encrypted storage media, focusing on encryption and key management. It consists of using cryptographic primitives to efficiently encrypt and decrypt data in any sector, using only a constant amount of additional storage independent of the size of the device. Its effectiveness depends on the secrecy of the chosen key and on the algorithm being used, which means that an adversary who can observe the device, intercept some plain texts and recover their cipher text, shall not be able to disclose the information stored in other sectors, unless the key is known.

There are two types of disk encryption: file-system-level encryption, which will encrypt the contents of a file or folder, and whole-disk encryption, in which all bits that go into the disk are encrypted, including bootable operating system partitions. Most whole-disk encryption solutions will use the same key to encrypt all the data in the disk, which means that an attacker who gains access to the disk and manages to get hold of the key, will get access to all data in the disk.

One issue about whole-disk encryption is that the blocks where the operating system is stored need to be decrypted before the computer can use them and load the operating system. This is achieved by completing a pre-boot authentication process, which will ensure that a small, highly secure operating system passes several integrity checks, and that the key to decrypt the data in the disk is not decrypted without an external input to the system. The small highly secure operating system is usually combined with TPM operations, in order to increase its security, and this can be used to bind a hard disk drive to a particular device, thus preventing the hard disk to boot if attached to another device. The external input requested as part of the pre-boot authentication process can be knowledge-based, such as a Personal Identification Number (PIN) or a password, possession-based, such as a smart-card or a USB token, or a combination of both.

While several solutions exist for disk encryption, including hardware and software based, TPM enabled or not, commercial and free, these are not included and enabled by default when one acquires a new computer and often require a more experienced user to setup. This violates the principle that a system should be secure by default, as access to the data inside the computer should be denied unless explicitly allowed, but it is not, and one could also argue that it also goes against the principle of psychological acceptability [55], as setting up these solutions is not a clear process and using them might be harder than if they were not there.

As a quick example, Mac OS X 10.3 and later ship with FileVault [61], which allows a user to encrypt the entire home directory. In order to use it, one has to set up a master password that can be used if one forgets the login password, i.e., the user will have to remember one password that is seldom used, just in case he or she forgets the one usually required to have access to the computer. Another example, Windows BitLocker Drive Encryption [62], which can only be used on some versions of Windows Vista and is not enabled by default, requires a specific drive configuration before being used, but that is not the default configuration. In order to obtain the required drive configuration, the user will have to find, in the installation CD, a specific tool and use it. In addition, it also requires a TPM by default, which means that, if one is not available, the user will have to find some obscure settings to disable this. None of these examples seem very user-friendly!

Even if cryptography is used and whole-disk encryption is deployed, it does not mean that the contents of the hard disk are secure. When a computer uses hard disk encryption it is vulnerable to cold-boot attacks [63], which take advantage of the DRAM remanence phenomenon to obtain the decryption keys from memory, since they need to be there in the first place to decrypt the contents of the hard disk. In order to accomplish such attack, a malicious user would need to have physical access to the computer while it is on and then proceed in one of the following ways:
reboot the computer and launch a custom kernel that allows the contents of the memory to be read;
temporarily interrupt the power to the machine, and then restore it, which prevents the operating system from clearing the memory, and booting a custom kernel that allows the contents of the memory to be read;
cut the power to the machine, freeze the DRAM modules, possibly by using some cooling substance such as liquid nitrogen, plug them into another computer, which is prepared to poll the keys and, in the end, put them back into the original computer.

These attacks clearly require a powerful attacker, and the third one even requires some knowledge about hardware, so whole-disk encryption is much better than nothing.

Trusted Computing Group [8], which is responsible for the specification of TPM, states that a computer is only subject to this problem if it is in sleep mode, i.e., when the data is not cleared from memory, as opposed to hibernation mode. In addition, the problem is no worse than having physical access to the USB or FireWire ports while the computer is on and nobody is looking, as an attacker could run special programs to dump the contents of the main memory and retrieve the encryption keys. This latter approach is certainly easier to accomplish, without being noticed, than conducting a cold-boot attack on the computer.

The last paragraphs have shown that whole-disk encryption is the best approach to keeping one's data secure, even though it may be subject to several kinds of attacks that require physical access to the computer while it is on or in sleep mode. However, whole-disk encryption is not the default setting when one buys a new a computer, so data is not really secure by default.

2.5 Cost of the Extra Technology

In the previous sections, the TPM, GSM and GPS concepts have been introduced and the functionality behind them highlighted. Since they are at the heart of this solution, it is important to understand the additional cost that one would incur in order to have this technology added to a computer, assuming that the computer does not include it by default.

Even though it is not possible to provide an exact estimation on the cost, as electronic component manufacturers usually have lower prices for retailers, it is possible to provide a rough estimation on the total cost of the extra equipment, based on the retail prices.

From the prices, one can easily determine that the total value of the additional equipment is really low when compared against the value of the data inside any computer.

### SUMMARY

The disclosed subject matter is related to methods, systems and computer program products for securing a computing device with data storage, power-on firmware—BIOS, geolocation and mobile data module—GPS/GSM, and a Trusted Platform Module—TPM, including establishing a shared-secret between the BIOS and the TPM, requesting the TPM to generate suitable encryption keys, namely for encrypting the data storage, supplying the user of the computing device suitable keys for external storage, calculating a hash-based message authentication codes over the BIOS, MBR, unique ID of the TPM, unique ID of the GPS/GSM module and unique ID of the BIOS; using user provided password and/or token device; using mobile data messages to secure the device if misplaced.

### BRIEF DESCRIPTION OF THE SEVERAL VIEWS OF THE DRAWINGS

The figures are provided as illustrations which facilitate an understanding of the invention and are not to be seen as limiting the scope of the invention, but merely illustrating some exemplary embodiments of the invention.

FIG. 1: Assisted GPS operation

FIG. 2: SMS contents when the computer is reported stolen

FIG. 3: SMS with location information provided by computer being tracked

FIG. 4: SMS sent by device to stop tracking

FIG. 5: Architecture of the components in the computing device

FIG. 6: Architecture of the tracking servers

### DETAILED DESCRIPTION

Everyone knows that data is valuable. The more valuable it is, the more priceless it becomes to replace if it is lost or stolen. Some solutions exist that can protect data from unauthorized disclosure, and these usually resort to some form of cryptography, and backup solutions can be used to recover data if a disaster happens. However, most users do not take advantage of these solutions for several reasons, both technical and social.

Tools that assist in recovering a misplaced computer exist, but they require the computer to connect to the Internet in order to be located. In addition, they are usually extra software that needs to be installed in the computer, so they also end up not being used as much as it would be desirable.

This work builds on the concepts employed by these tools and solutions, and uses some additional technology available nowadays, in order to ensure confidentiality and traceability by default. A TPM is used for confidentiality of the data and a GPS/GSM module provides traceability information, without violating the user's privacy. The integration of this extra technology comes at an additional cost, but the user is likely to be willing to pay for it, in particular when it is compared with the cost of losing data. The usage of such technology does not put an additional burden on the user, and the usability level of the whole system is not significantly changed, as most complex operations are only done once and regular operation is performed in a user-friendly and almost transparent way.

The approach being proposed is in part somewhat similar to already existing tools and techniques [5, 6] used for locating and stopping a vehicle that has been stolen [7]. However, strange as it may seem, these tools and techniques have never been combined and applied to detecting, locating and recovering a computer, at least as far as the author knows. Could it be that a car is more valuable than a computer with several hundred or thousand private and even confidential documents? It is clear that the price of a car is much higher than the price of a computer, but if we value the information contained inside the computer and consider the full extent of having the computer misplaced and losing all the data inside, then the situation is reversed.

It resorts to Trusted Platform Modules (TPM), Global System for Mobile communications (GSM) and Global Positioning Systems (GPS), combines them in order to achieve these goals in a user-friendly way, and minimizes the chances of being detected by the person holding the computer after it has been snatched.

### 3. Confidentiality by Default

As mentioned in 2.4.2, disk encryption techniques can be used to protect data inside a computer, but the default is that these methods are not usually active. Existing solutions, such as FileVault [61], Windows BitLocker Drive Encryption [62], and PGP Whole Disk Encryption [68], require explicit actions by the end-user in order to become active in the operating system, or may be inadequate for the user's needs, so they end up not being used as often as it would be desirable. With the advent of TPM chips, and their inclusion in consumer-grade devices, it is easy to predict that many solutions will appear and take advantage of such chips and their functionality.

FileVault, for example, creates an encrypted disk image where the contents in the home folder are stored, which means that everything in the home directory is stored inside one single file. This of course means that anything outside the home folder is not encrypted, and also that, if the disk image gets corrupted beyond repair, the user will probably lose everything inside.

BitLocker, as another example, is only included with Windows Vista Enterprise, Windows Vista Ultimate and Windows Server 2008, but is not installed or active by default. PGP Whole Disk Encryption provides partition-level encryption, but it is a third-party software package which needs to be installed in the target computer. While BitLocker is designed to work with a TPM, but can be made to work without one, PGP Whole Disk Encryption does not require a TPM.

The lack of usage of such tools might have several reasons. It might be because users do not know how to do it, are afraid of breaking something or losing their data, it might be because there is no motivation to do it or it might be because they do not address the user's needs. This of course leaves the data unprotected in the computer. Unfortunately, most people only understand the real issue when their private files, such as home videos or photographs, appear on the Internet or, in case of industrial secrets, when they are used by competitors. Therefore, it is important to consider solutions that overcome these limitations and provide confidentiality by default for the user data.

Educating users towards security can be a demanding, time-consuming and sometimes even frustrating task, and one cannot expect regular users to start using something if they do not understand what it is, what it does, or why it is needed. So it is up to technical people to invent solutions that provide them additional security, preferably without making their life harder.

For the first part of this work, an initial approach to introduce confidentiality by default in computers is provided. Adding confidentiality by default is done in such a way that it can be used by all kinds of users, regardless of their experience, and extending the functionality already provided by existing solutions. In order to achieve that goal, a TPM will be used, together will whole-disk encryption, to ensure that data remains confidential inside the hard disk of the computer.

3.1 First Step: Adding a TPM and a Compatible BIOS

The first step in this present approach must be taken into account while assembling the main circuit board that will be used in the computer. The manufacturer must include a TPM device and a TPM-compatible BIOS, or equivalent system in other architectures. That BIOS must be prepared to read information from a USB device, during the Power-On Self Test (POST) sequence of the computer. In addition, the BIOS needs to execute the Authorisation-Data Insertion Protocol [9] with the TPM, which will establish a shared-secret between the BIOS and the TPM. This shared-secret proves that the BIOS is authenticated and authorised to use the TPM API.

3.2 Second Step: Operating System Installation

The operating system is a very important component in the system and no computer will be useful if it does not have an operating system installed. The operating system installation is usually conducted by technical-oriented people, which can be tech-savvy end-users, installing the operating system of their choice, or the manufacturer's staff performing a pre-installation of the operating system into the computer before it is shipped. It is safe to assume that this operation is done in a controlled environment where the computer is not subject to robbery, at least most of the time. Even if the computer is stolen during the period in which the operating system is being installed, it is very likely that it does not contain any data, at least in most cases, so the loss would only concern the hardware value and this could easily be covered by insurance.

Regardless of the user installing the operating system, for this present approach the installation needs to behave like the pre-installations that come with computers when a consumer buys them, before the following steps can be taken. This means that the operating system installation must be completed in two steps, with the first step formatting the hard drive, if needed, performing the copies of the operating system files, setting up the hardware and configuring the minimum services required to boot the computer into the next step of the installation.

For the simplicity of the process at this time, the TPM is assumed to be disabled, so that it does not get in the way of any changes that the operating system installation may need to perform on the computer. If it is not disabled, then it is assumed that it can be disabled by providing the TPM owner password or by resetting it.

Once the operating system is pre-installed into a computer, there are still a few operations that need to be performed before the computer can be used. These operations are only carried by the end customer and usually consist of defining any regional settings, as well as creating a username and password for logging into the operating system. Some operating systems may not require that a username and password be created, but in order to achieve the a very basic level of security, that operation must be enforced. This very basic level of security only ensures that one user is not able to read the documents of the other users.

If the operating system does not require any username and password to be entered, then anyone who turns on the computer will have automatic access to all the data inside, which is not really desirable. Even though access to the data can be bypassed if one gains physical access to the computer, for example by using the techniques described in 2.4.1, using a user and a password allows one to implement a separation of privileges access control policy [55], identifying which users are allowed to access which resources. This very basic level of security also provides the simplest form of confidentiality between regular users, i.e., users without administrative privileges, as one user's data is kept confidential from other users.

3.3 Third Step: Taking Ownership of the Computer

In order for the TPM to perform its operations, its ownership needs to be taken and it needs to be enabled. Since the TPM had been disabled because of the operating system installation, the operating system will now assist the user in enabling and taking ownership of the TPM. During that process, if the TPM has had its ownership taken in the past, then the user must provide the appropriate TPM owner password before it can be activated. The user is only allowed to provide an incorrect TPM owner password a certain number of times, before the TPM completely locks access to the computer. If the user enters the correct TPM owner password, he is allowed to change it by entering a new one. Once a TPM owner password has been provided and the TPM has been activated, the user defines the number of times an invalid TPM owner password can be provided before the computer is locked down, and he is allowed to store the TPM owner password in some external storage. The complete process is detailed in Table 3.1.

At this time the TPM is enabled and its ownership has been taken. As a result, any operation that changes the TPM state needs to be confirmed by the TPM owner password. This process consists of the following operations:

1. User, or operating system working on behalf of user, issues, via the TPM API, a command that requires the TPM owner password, and provides the TPM owner password;

2. The TPM verifies that the provided owner password matches the one sealed inside the TPM;

3. If the two passwords match, then the operation is allowed and the counter for the number of invalid TPM owner passwords is reset to zero;

4. If the two passwords do not match, then the TPM adds one to the counter of invalid TPM owner passwords entered and, if the limit defined by the user has been reached it block access to the computer, by preventing it from booting.

In order to keep the simplicity of the protocols described in the following sections, and to focus on their most important activities, these steps shall be omitted.

TABLE 3.1
Ownership Takeover Protocol

| | | Actions | Description |
|---|---|---|---|
| 1. | OS → TPM | enableTPM( ) | OS enables the TPM via the TPM API |
| | TPM → User | askPassword( ) | TPM asks the user to enter the TPM owner |
| | | | password |
| 2. | User → TPM | P_{Owner} | user enters its TPM owner password P_{Owner} |
| | | | (or reads it from a USB device, if ownership had |
| | | | been taken before) |
| 3. | TPM | ownTaken( )? | if TPM detects that ownership has been taken |
| | (User → TPM) | repeat step 2 until | in the past: |

| | | |
|---|---|---|
| (P_{Owner} = TPM_{Owner} | 1. | TPM checks if the TPM owner password |
| OR MaxTries | | (TPM_{Owner}) stored inside the TPM |
| exceeded) | | matches the one provided by the user |
| | | (P_{Owner}) |
| | 2. | it both passwords do not match, the user |
| | | is asked to enter the password (P_{Owner}) |
| | | again, up to the number of times allowed |
| | | by the TPM (MaxTries) before locking |
| | | access to the computer. In the latter scenario, |
| | | the protocol ends. |

| | | | |
|---|---|---|---|
| 4. | TPM | ownTaken( ) AND | if TPM ownership had been taken in the past |
| | (User → TPM) | changeWanted( )? | (earlier than this execution) and user wants to |
| | | P_{ONew} | change the password, user enters another TPM |
| | | TPM_{Owner} ← P_{ONew} | password (P_{ONew}), which the TPM stores as |
| | | | the new TPM owner password |
| 5. | User → TPM | MaxTries ← T | user defines maximum number T of invalid attempts |
| | | | to enter the TPM owner password before |
| | | | the TPM locks access to the computer |
| 6. | TPM → User | pwdChanged( )? | if the TPM_{Owner} was changed, the TPM asks |
| | | TPM_{Owner} | the user to store it in some storage media, such |
| | | | as a USB device |

3.4 Fourth Step: Activating Disk Encryption

Now that the TPM is active and the user has taken ownership of the computer, it is time to activate disk encryption, which will provide additional data confidentiality. In order to activate disk encryption, the final step of the operating system installation will invoke the TPM API and ask the TPM to perform a number of operations, while at the same time assisting the user through the process.

The TPM must generate and store an encryption key, which it must use to encrypt the contents of the hard disk. The user is asked to store the encryption key in some external storage, which allows the user to still have access to the data if he needs to attach the hard disk to another computer. Additionally, the TPM calculates and stores a HMAC value over some components in the computer.

The HMAC signature s1 will be used whenever the computer starts up, to ensure that the components have not been changed since the HMAC value was last calculated. The user is asked to store the HMAC h1 value and the signature s2, so that they can later be used if there is a logical error in the disk. Should that situation occur, the user would be able to force the TPM to continue the execution of the Basic Pre-boot Validation Protocol. That operation is detailed later in 3.4.1.

The entire process to activate disk encryption is detailed in Table 3.2.

TABLE 3.2
Basic Data Confidentiality Protocol

| | | Actions | Description |
|---|---|---|---|
| 1. | OS → TPM | generate Key( ) | OS asks the TPM to generate an encryption |
| | | | key |
| 2. | TPM | K_{Disk} | TPM generates K_{Disk} |
| 3. | TPM | HD ← E (K_{Disk}, HD) | TPM encrypts the hard disk (HD), or the active |
| | | | partition if there is more than one, with K_{Disk} |
| | | | (leaving the Master Boot Record (MBR) unencrypted) |
| 4. | TPM → User | K_{Disk} | TPM asks user to store K_{Disk} in an external |
| | | | device |
| 5. | TPM | K_{Owner} ← | TPM deterministically derives a key K_{Owner} |
| | | f (TPM_{Owner}) | from the TPM owner password TPM_{Owner} |
| 6. | TPM | M1 ← from + | TPM calculates a SHA-1 HMAC, using |
| | | BIOS + MBR + | K_{Owner}, over the computer firmware (firm) |
| | | #TPM + #BIOS | and BIOS (BIOS), the MBR (MBR) and the |
| | | M2 ← firm + | serial numbers of the TPM (#TPM) and the |
| | | BIOS + #TPM + | BIOS (#BIOS) |
| | | #BIOSh₁ ← | TPM calculates a similar SHA-1 HMAC, using |
| | | HMAC(K_{Owner}, M1) | K_{Owner}, over the same components, but excluding |
| | | h₂ ← | the MBR |
| | | HMAC(K_{Owner}, M2 >) | |
| 7. | TPM | s₁ ← S(Eₖᵣ, h₁) | TPM signs each of the HMAC values with the |
| | | s₂ ← S(Eₖᵣ, h₂) | private part of its endorsement key (Eₖᵣ), and |
| | | | stores the resulting s₁ value inside the TPM |
| 8. | TPM → User | h₁, s₂ | TPM asks the user to store the HMAC h₁ value |
| | | | and the signature s₂ in an external device |
| 9. | TPM | K_{Master} ← g(h₁) | TPM generates another encryption key |
| | | | K_{Master}, deterministically derived from the |
| | | | HMAC value calculated earlier |
| 10. | TPM | K_{Disk} ← | TPM encrypts K_{Disk} with K_{Master}, stores the |
| | | E(K_{Master}, K_{Disk}) | resulting value in the TPM, and disposes of |
| | | K_{Master} ← NULL | K_{Master} |

By following that process, one has achieved a very basic level of data confidentiality, since the data in the disk is encrypted with a key that is stored inside the TPM and also by the user. However, if a username and a password have not been defined during the operating system installation, then any user who gains physical access to the computer will have access to the data, as the computer will pass the Basic Pre-boot Validation Protocol, described in 3.4.1, the operating system will start and full access to the computer will be provided. This demonstrates the importance of demanding that a login username and password be defined during the final steps of the operating system installation.

Even if a login username and password are required by the operating system, a malicious user could still gain access to the data, for example by trying to guess the password, if it is an easy one, or by following one of the techniques described in 2.4.2, which could allow him to obtain the disk encryption key. In the latter case, he could just plug the hard disk to another computer and use the retrieved key to decrypt the hard disk contents.

Both the Ownership Takeover Protocol, defined in Table 3.1, and the Basic Data Confidentiality Protocol, defined in Table 3.2, require the user to store some information in an external device. While storing the TPM owner password, which is not the same as KOwner, the encryption key KDisk, the HMAC value and the signature s2 in the same external media would not bring any problems, it is not recommended.

The TPM owner password is only required to perform operations that change the state of the TPM, such as enabling or disabling it, KDisk will be required to decrypt the data in the hard disk, if the TPM is changed or is not present, the HMAC h1 value and the signature s2 will be required in case there is a logical error in the disk while it is starting up. Recalling the principle of least privilege [55], it is easy to understand that there are three different levels of privileges here, in particular if the computer belongs to an enterprise. Typically, the common user will only need the HMAC h1 value and the signature s2, while system administrators will be able to use KDisk if they need to plug the disk into another computer. Finally, a superuser would be able to use the TPM owner key if he needs to perform maintenance tasks on the TPM.

Even if the computer belongs to an individual instead of an enterprise, there are still advantages in keeping the TPM owner password, KDisk, the HMAC h1 value and the signature s2 in different locations, as it is not expected that they need to be used with the same frequency. The HMAC h1 value and the signature s2 would be used in case of logical errors in the disk, which would be the most common problem, KDisk would be used if the disk needed to be connected to another computer, which should happen less frequently, and finally the TPM owner key would only be used for maintenance tasks that required changes to the TPM, which should be the least frequent of the scenarios.

Since the level of confidentiality is very basic at this time, storing those items in different locations does not seem to be very important, and one might even question if that is needed at all. However, the real importance of doing so will become much clear later in this chapter.

3.4.1 Basic Pre-Boot Validation

When a computer starts, the BIOS executes some power-on self tests before transferring control to the operating system. If a TPM is present and active, it too can perform some checks before allowing the process to continue, which is the case in the scenario being described. Those operations are described in Table 3.3, continued in 3.4.

TABLE 3.3
Basic Pre-boot Validation Protocol (I)

| | | Actions | Description |
|---|---|---|---|
| 1. | TPM | K_{Owner} ← | TPM retrieves the TPM owner password |
| | | f (TPM_{Owner}) | (TPM_{Owner}) stored inside the TPM |
| | | | TPM deterministically derives a key K_{Owner} |
| | | | from the TPM owner password TPM_{Owner} |
| 2. | TPM | MP ← firm + | TPM calculates a SHA-1 HMAC, using |
| | | BIOS + MBR + | K_{Owner}, over the computer firmware (firm) |
| | | #TPM + #BIOS | and BIOS (BIOS), the MBR (MBR) and the |
| | | h_{1′} ← | serial numbers of the TPM (#TPM) and the |
| | | HMAC(K_{Owner}, M1′) | BIOS (#BIOS) |
| | | s_{1′} ← S(Eₖᵣ, h_{1′}) | TPM signs the HMAC with the private part of |
| | | | its endorsement key |
| 3. | TPM | s₁ | TPM retrives the signature s₁ of the HMAC |
| | | s_{1′} = s₁? | value stored inside the TPM, which was calculated |
| | | | during the Basic Data Confidentiality Protocol |
| | | | TPM compares the calculated value s₁, with |
| | | | the stored value s₁. If no component in the computer |
| | | | has been changed, then these values will |
| | | | match, and the computer continues this flow in |
| | | | step 8. |
| 4. | TPM | M2′ ← | TPM calculates a SHA-1 HMAC, using |
| | | firm + BIOS + | K_{Owner}, over the computer firmware and BIOS, |
| | | #TPM + #BIOS | and the serial numbers of the TPM and the |
| | | h_{2′} ← | BIOS |
| | | HMAC(K_{Owner}, M2′) | TPM signs the HMAC with the private part of |
| | | s_{2′} ← S(Eₖᵣ, h_{2′}) | its endorsement key |
| 5. | User → TPM | h_{1′}s₂ | TPM asks the user to provide the HMAC value |
| | | | and the signature s₂, that were stored during |
| | | | the Basic Data Confidentiality Protocol |
| | | | If the user cannot provide that information, the |
| | | | boot process is stopped, the computer does not |
| | | | load the operating system, and the subsequent |
| | | | steps are not performed |
| 6. | TPM | s_{2′} = s₂? | TPM compares the user provided value s₂ with |
| | | | the calculated value s_{2′}. If these do not match, |
| | | | then the signatures do not verify, the boot process |
| | | | is stopped, and the subsequent steps are |
| | | | not performed |
| 7. | TPM | s_{1″} ← S(Eₖᵣ, h₁) | TPM signs the HMAC h₁ provided by the user |
| | | s_{1″} = s₁? | with the private part of its endorsement key |
| | | | TPM compares the signature s_{1″} with the |
| | | | stored value s₁. II If matches the the HMAC |
| | | | provided by the user has not been lampered |
| | | | and can be used to calculate K_{Master}. If they do |
| | | | not match, then the booting process is stopped |
| | | | and the subsequent steps are not performed. |
| 8. | TPM | K_{Master} ← g(h₁) | TPM generates another encryption key |
| | | | K_{Master}, deterministically derived from h₁ |

TABLE 3.4
Basic Pre-boot Validation Protocol (II)

| | | Actions | Description |
|---|---|---|---|
| 9. | TPM | K_{Disk} ← | TPM uses K_{Master} to decrypt [symbol] stored |
| | | D (K_{Master}, | inside the TPM |
| | | [symbol] ) | |
| 10. | TPM | HD ← | TPM uses K_{Disk} to decrypt the hard disk [symbol] , |
| | | D (K_{Disk}, | disposes of K_{Master}, and allows the operating |
| | | [symbol] ) | |
| | | K_{Master} ← | system to start executing |
| | | NULL | |

The process starts with the TPM retrieving the TPM owner password stored inside and using it to deterministically derive a key KOwner. This key generation procedure uses the same deterministic algorithm that was used during the Basic Data Confidentiality Protocol, and the same input, thus produces the same key. That same key is then used to calculate the HMAC value over some components inside the computer, which the TPM signs with the private part of its endorsement key, just as in the Basic Data Confidentiality Protocol. Since the algorithm, the keys and the input are the same, the same value will be produced.

If the calculated HMAC value is not the same as the one stored inside the TPM, then one of the components used to calculate the HMAC has changed. It might have been a logical error in the MBR part of the disk, or some of the components might have been tampered, and the computer should not, in principle, continue the booting process. However, since logical errors can occur more frequently than would be desirable, the TPM calculates the same HMAC, but excluding the MBR of the disk, and the user is asked to enter the HMAC h1 value and the signature s2 that had been stored earlier during the Basic Data Confidentiality Protocol.

The TPM checks if the calculated s2. matches the provided s2. Recall that during the Basic Data Confidentiality Protocol (Table 3.2), the TPM had calculated a HMAC over some components in the computer (step 6), signed it with a key that is only known by the TPM (step 7), and that value had been stored by the user (step 8).

If the value calculated and signed by the TPM, using the private part of its endorsement key, during the Basic Pre-boot Validation Protocol (step 4) matches the one provided by the user (steps 5, 6) during the same process, then the TPM knows that there must have been a logical error in the MBR, as this was the only value that was not included in the HMAC calculations (step 6 in the Basic Data Confidentiality Protocol, step 4 of the Basic Pre-boot Validation Protocol) in both protocols. Furthermore, the TPM knows that the s2 signature provided by the user has not been tampered, because it would not match the one calculated by the TPM.

However, knowing that a logical error occurred in the MBR is not enough to proceed, as the TPM needs the correct HMAC value, i.e., the one that includes the MBR, in order to generate the key that encrypts the disk encryption key, but the TPM does not store this value. Nevertheless, the user had stored this value during the Basic Data Confidentiality Protocol, and can provide it to the TPM.

The TPM needs to verify that the HMAC value provided by the user has not been tampered. In order to do this, the TPM signs that value using the private part of its endorsement key (step 7) and verifies that the calculated value matches the one sealed inside the TPM. Only the TPM can sign something with its private key, so the signature cannot be forged. At this time, the TPM can use that HMAC to derive KMaster (step 8), using it to decrypt KDisk stored inside the TPM (step 9). Once again, the key generation procedure uses the same deterministic algorithm that was used during the Basic Data Confidentiality Protocol. It receives the same input, and as result produces the same key.

When KDisk has been decrypted, it is used to decrypt the hard disk!

HD and the operating system is allowed to start booting the computer.

3.4.2 Limitations of the Basic Pre-Boot Validation Protocol

The Basic Pre-boot Validation Protocol does not prevent a malicious user from gaining access to the data, because it only relies on information that the computer components will provide while booting. The exception is, of course, when logical errors occur in the MBR and the user has to provide input for the Basic Pre-boot Validation Protocol to proceed, but that is not the only scenario in which data confidentiality should be enforced. So, as long as the components used to calculate the HMAC do not change (steps 2 and 3 of the Basic Pre-boot Validation Protocol), the computer will start, the operating system will load, and a malicious user will be able to gain access to the data.

In order to overcome this limitation, an approach inspired by the concept behind the AEGIS architecture [13] is followed. In that architecture, integrity checks are performed on the lower layers of a system and control is only passed to the higher layers if those integrity checks verify. Additionally, that concept is enhanced with something similar to what is performed by Windows BitLocker [69, 70], and it requires that the computer is only able to start after the user has entered something that is known, e.g. a password, or provided proof of ownership, for example with a token. Some of the steps from the procedure described in Table 3.2 are reused, some others are changed and others are introduced, so that the user is asked if he wants to use additional security by entering a boot password, by using a token or both. The complete process now needs to invoke other methods on the TPM API, so that the extra functionality can be used. The updated flow can be seen in Table 3.5, continued in Table 3.6.

When that flow is executed, the data inside the computer is kept confidential and the level of confidentiality is indexed to the security of the password, token or both, as the computer will now require the user to enter a password, or present a token, before the Pre-boot Validation Protocol is completed. If a malicious user gains access to the computer but does not have the startup token or password, then the computer will not boot and the confidentiality of the data is ensured. Just as in the Basic Data Confidentiality Protocol, if the disk is connected to another computer, the disk encryption key needs to be provided in order to obtain access to the data. The details about the Extended Pre-boot Validation Protocol are described in Section 3.5.

The XOR operation in step 9 of the procedure is meant to produce intertwined intermediary values, ensuring that the possession of either KOwner or the user password alone is not enough to obtain the disk encryption key, and thus to recover the data. The split storage of KDisk encrypted with KMaster in the end introduces another level of difficulty and indirection for an attacker trying to recover KDisk. This technique is known as secret-splitting, or secret sharing, and has been around for many years. It consists of splitting a secret into two or more parts, just like pirates used to do with maps, in such a way that one of the parts alone is not enough to reveal anything about the secret or what it is protecting. Therefore, the XOR operation and the secret-splitting ensure that only the holder of all the secrets can have access to the data.

TABLE 3.5
Enhanced Data Confidentiality Protocol (I) (upgrades from the Basic Data
Confidentiality Protocol in Table 3.2, in bold)

| | | Actions | Description |
|---|---|---|---|
| 1. | OS → TPM | generateKey( ) | OS asks the TPM to generate an encryption |
| | | | key |
| 2. | TPM | K_{Disk} | TPM generates K_{Disk} |
| 3. | TPM | HD ← E (K_{Disk}, HD) | TPM encrypts the hard disk (HD), or the active |
| | | | partition if there is more than one, with K_{Disk} |
| | | | (leaving the Master Boot Record (MBR) unencrypted) |
| 4. | TPM → User | K_{Disk} | TPM asks user to store K_{Disk} in an external |
| | | | device |
| 5. | User → TPM | password | user optionally enters a password, pass |
| | | | phrase or PIN (referred simply as password |
| | | | in the subsequent steps) |
| 6. | User → TPM | useToken | user optionally chooses to have a token |
| | | | (referred as startup token in the remainder |
| | | | of this section) |
| 7. | TPM | flags | TPM stores a 2-bit value indicating if the |
| | | | user wants to use a password, a token or |
| | | | both |
| 8. | TPM | K_{Owner} ← | TPM retrieves the TPM owner password |
| | | f (TPM_{Owner}) | (TPM_{Owner}) stored inside the TPM |
| | | | TPM deterministically derives a key K_{Owner} |
| | | | from the TPM owner password TPM_{Owner} |
| 9. | TPM | M1 ← firm + BIOS + | TPM calculates a SHA-1 HMAC, using |
| | | flags + MBR + | K_{Owner}, over the computer firmware (firm), |
| | | #TPM + #BIOS | BIOS (BIOS) and TPM flags (flags), the MBR |
| | | M2 ← | (MBR) and the serial numbers of the TPM |
| | | firm + BIOS + flags + | (#TPM) and the BIOS (#BIOS): |
| | | #TPM + #BIOS | if the user enters a password: using |
| | | h₁ ← | K_{Owner} XOR-ed with the input password |
| | | HMAC(K_{Owner} [symbol] | else: using just K_{Owner} |
| | | password, M1) | TPM calculates a similar SHA-1 HMAC, using |
| | | h₂ ← | K_{Owner}, over the same components, but |
| | | HMAC(K_{Owner} [symbol] | excluding the MBR |
| | | password, M2) | |
| 10. | TPM | s₁ ← S(Eₖᵣ, h₁) | TPM signs each of the HMAC values with the |
| | | s₂ ← S(Eₖᵣ, h₂) | private part of its endorsement key (Eₖᵣ), and |
| | | | stores the resulting s₁ value inside the TPM |
| 11. | TPM → User | h₁, s₂ | TPM asks the user to store the HMAC h₁ value |
| | | | and the signature s₂ in an external device |
| 12. | TPM | K_{Master} ← g (h₁) | TPM generates another encryption key |
| | | | K_{Master}, deterministically derived from the |
| | | | HMAC value calculated earlier |

TABLE 3.6
Enhanced Data Confidentiality Protocol (II) (upgrades from the Basic Data
Confidentiality Protocol in Table 3.2, in bold)

| | | Actions | Description |
|---|---|---|---|
| 13. | TPM | K_{Disk} ← | TPM encrypts K_{Disk} with |
| | | E (K_{Master}, K_{Disk}) | K_{Master} |
| 14. | TPM | useToken? | if the user chooses to use a |
| | TPM → User | X1 ← odd( [symbol] ) | token: |
| | | X2 ← even( [symbol] ) | TPM stores the even bits |
| | | | of the resulting value in |
| | | | the TPM; |
| | | | TPM asks the user to |
| | | | store the odd bits of the |
| | | | resulting value, called the |
| | | | startup key, in a USB |
| | | | device, called the startup |
| | | | device: |
| | | | else TPM stores the resulting |
| | | | value in the TPM |
| 15. | TPM | K_{Master} ← NULL | TPM disposes of K_{Master} |

Just as discussed in the Basic Data Confidentiality Protocol (Table 3.2) section, the user is allowed to store all required items in the same external media, but it is not recommended. The reasons for this are provided later in this chapter.

Additionally, depending on the TPM's manufacturer, it is possible to define the number of password entries and startup keys that one is allowed to enter incorrectly before the TPM completely locks the computer, thus enhancing this scheme to withstand brute-force attacks. Keeping the MBR unencrypted is necessary in order to perform the pre-boot validation sequence, i.e., in order for the TPM to validate that the MBR was not changed since the last time the TPM updated the HMAC. The MBR could in fact be encrypted, and this would mean that the TPM would have to store one more key, which it would use to decrypt the MBR, before calculating the integrity check.

For even extra security, Windows BitLocker [62] requires two partitions in the hard disk, one for the boot files and another one for the operating system, and a similar approach could be used here. In that scenario, the pre-boot validation sequence would calculate hashes over the files in the boot partitions, and it would stop if these files had been changed. In order to achieve such functionality, more cryptographic keys are used, one for the operating system partition and another for the boot partition, and they are used as parts of a chain of encrypted keys and hashed values. Once the boot partition has been decrypted, by following a process similar to the one proposed here, the key for the other partitions is obtained from that partition. It can then be used to have access to the data in those partitions. Confidentiality of the data in the other partitions is ensured as long as the confidentiality of the data in the boot partition holds.

3.5 The Pre-Boot Process

The pre-boot validation process occurs whenever the computer is turned on or is resumed from hibernation. During that process, the TPM verifies that no component has been changed, by performing several integrity checks against the computer components, asks the user to enter some data, and only allows the computer to continue booting if these integrity checks are correct. The process is detailed in Table 3.7, and continued in Table 3.8.

This process is very similar to the Basic Pre-boot Validation Protocol, and only some operations are changed. It starts with the TPM obtaining the TPM owner key and using it to deterministically derive KOwner. The flags value is retrieved, and according to their value, the user is asked for the boot password, the startup token or both, which the TPM uses to calculate the same HMAC that had been calculated during the Enhanced Data Confidentiality Protocol.

The HMAC value is then signed with the private part of the TPM's endorsement key, and verified against the value stored inside the TPM. If these values match, then none of the components used to calculate the HMAC has been tampered, and the boot process can continue, because only the TPM would be able to sign something with its private key. If the HMAC does not match, then, just as it happened in the Basic Pre-boot Validation Protocol, the TPM needs to collect additional information from the user before proceeding. The remainder of the process is the same as the Basic Pre-boot Validation Protocol, with the user providing the alternative HMAC and signature, calculated without taking into account the MBR, and the TPM verifying if they match the corresponding values stored inside (steps 6-8). The process ends with the TPM being able to determine KDisk, if the HMAC values match, decrypting the hard disk, and allowing the operating system to start its execution.

If the values do not match, even after a number of tries, the computer enters the recovery state, described later in 3.7.3.

3.6 Using the Computer

When the computer is started or resumed from hibernation, the BIOS will transfer the control to the TPM and it will execute the Extended Pre-boot Validation Protocol. Only if it succeeds will the operating system start. Since the data in the disk is encrypted with KDisk and that key is stored encrypted inside the TPM, with a key that depends on something the user knows (password), something the user has (startup token), or both, data will remain confidential and thus confidentiality by default has been achieved.

If the user has more than one partition in the disk and wants to enforce confidentiality for the data inside the other partitions, then the operating system should provide the user with the ability to encrypt those partitions, using a different key generated by the TPM, storing that key as a file in the originally encrypted partition, and using it to decrypt the other partitions when required. So, the confidentiality of the data inside the other partitions would be ensured as long as the confidentiality of the data inside the main partition was not compromised.

TABLE 3.7
Extended Pre-boot Validation Protocol (I) (upgrades from the Basic Pre-Boot
Validation Protocol in Tables 3.3 and 3.4, in bold)

| | | Actions | Description |
|---|---|---|---|
| 1. | TPM | K_{Owner} ← | TPM retrieves the TPM owner password |
| | | f (TPM_{Owner}) | (TPM_{Owner}) stored inside the TPM |
| | | | TPM deterministically derives a key K_{Owner} |
| | | | from the TPM owner password TPM_{Owner} |
| 2. | User → TPM | flags = | TPM retrieves the Flags value |
| | | useToken?, flags = | If the Flags say that a token, a boot password, |
| | | passwd? | or both are required, then they are |
| | | token, password | provided by the User |
| | | | Failure to provide these inputs causes the |
| | | | boot process to stop |
| 3. | TPM | M1′ ← | TPM calculates a SHA-1 HMAC, using |
| | | firm + BIOS + | K_{Owner}, over the computer firmware (firm), |
| | | flags + MBR + | BIOS (BIOS) and TPM flags (flags), the MBR |
| | | #TPM + #BIOS | (MBR) and the serial numbers of the TPM |
| | | h_{1′} ← | (#TPM) and the BIOS (#BIOS): |
| | | HMAC(K_{Owner} [symbol] | if the user enters a password: using |
| | | password, M1′) | K_{Owner} XOR-ed with the input password |
| | | s_{1′} ← S(Eₖᵣ, h_{1′}) | else: using just K_{Owner} |
| | | | TPM signs the HMAC with the private part |
| | | | of its endorsement key |
| 4. | TPM | s₁ | TPM retrieves the signature s₁ of the HMAC |
| | | s_{1′} = s₁? | value stored inside the TPM, which was calculated |
| | | | during the Enhanced Data Confidentiality |
| | | | Protocol |
| | | | TPM compares the calculated value s₁, with |
| | | | the stored value s₁. If no component in the computer |
| | | | has been changed, then these values will |
| | | | match, and the computer continues this flow in |
| | | | step 9. |
| 5. | TPM | M2′ ← | TPM calculates a SHA-1 HMAC, using |
| | | firm + BIOS + flags + | K_{Owner}, over the computer firmware (firm), |
| | | #TPM + #BIOS | BIOS (BIOS) and TPM flags (flags), and the |
| | | h_{2′}← | serial numbers of the TPM (#TPM) and the |
| | | HMAC(K_{Owner} [symbol] | BIOS (#BIOS): |
| | | password, M2′) | if the user enters a password: using |
| | | s_{2′}← S(Eₖᵣ, h_{2′}) | K_{Owner} XOR-ed with the input password |
| | | | else: using just K_{Owner} |
| | | | TPM signs the HMAC with the private part |
| | | | of its endorsement key |

TABLE 3.8
Extended Pre-boot Validation Protocol (II) (upgrades from the Basic Pre-Boot
Validation Protocol in Tables 3.3 and 3.4, in bold)

| | | Actions | Description |
|---|---|---|---|
| 6. | User → TPM | h₁, s₂ | TPM asks the user to provide the HMAC value |
| | | | and the signature s₂, that were stored during |
| | | | the Enhanced Data Confidentiality Protocol |
| | | | If the user cannot provide that information, the |
| | | | boot process is stopped, the computer does not |
| | | | load the operating system, and the subsequent |
| | | | steps are not performed |
| 7. | TPM | s_{2′} = s₂? | TPM compares the user provided value s₂ with |
| | | | the calculated value s_{2′}, If these do not match, |
| | | | then the signatures do not verify, the boot process |
| | | | is stopped, and the subsequent steps are |
| | | | not performed |
| 8. | TPM | s_{1″} ← S(Eₖᵣ, h₁) | TPM signs the HMAC h₁ provided by the user |
| | | s_{1″} = s₁? | with the private part of its endorsement key |
| | | | TPM compares the signature s_{1″} with the |
| | | | stored value s₁. If it matches then the HMAC |
| | | | provided by the user has not been tampered |
| | | | and can be used ot calculate K_{Master}. If they do |
| | | | not match, then the booting process is stopped |
| | | | and the subsequent steps are not performed. |
| 9. | TPM | K_{Master} ← g (h₁) | TPM generates another encryption key |
| | | | K_{Master}, deterministically derived from h₁ |
| 10. | TPM | K_{Disk} ← | TPM uses K_{Master} to decrypt K_{Disk} stored |
| | | D (K_{Master}, [symbol] ) | inside the TPM |
| 11. | TPM | HD ← | TPM uses K_{Disk} to decrypt the hard disk HD, |
| | | D (K_{Disk}, [symbol] ) | disposes of K_{Master}, and allows the operating |
| | | K_{Master} ← NULL | system to start executing |

There are, however, some issues that remain to be solved with this approach, as depicted in the following subsections.

3.7 Solving Problems with this Approach

3.7.1 Disabling and Resetting the TPM

Some operations require the user to disable or reset the TPM. In order to update the computer hardware, the firmware, or software that needs to change the MBR, for example, the user will need to disable the TPM. Otherwise, any of the Pre-boot Validation Protocols would fail and the computer would no longer start. In this approach these operations can only be done by starting the computer, providing the startup password, token or both, and then entering the TPM owner password, which was configured when the user was taking ownership of the computer, as described in Section 3.3.

If the user needs to disable or reset the TPM, but does not know or cannot provide the TPM owner password, the TPM will ask for the KDisk key and, if the user is able to provide a valid one, the TPM will be triggered to reset itself to factory default data, which erases all keys and values stored inside, except for the endorsement key. The problem with this approach is that it is not easy for the TPM to understand what is a valid key and what is not, as all keys look the same and, in this present approach, the TPM does not store KDisk anywhere. So, the TPM will calculate KDisk from the TPM's internal state and from KMaster, asking the user for the appropriate inputs in order to derive the latter key, just as it is done in the Extended Pre-boot Validation Protocol (Table 3.7 and Table 3.8). Then, KMaster is used to encrypt KDisk and the resulting value is compared against the split-secret stored by the user and the TPM at the end of the Enhanced Data Confidentiality Protocol. If the combination of the parts stored by the user and the TPM match the calculated value, then the user provided KDisk is considered valid.

From this point on, the user is allowed to take ownership of the TPM again, define a new TPM owner password and regenerate the KMaster key and startup token, without having to ask the TPM to generate and use a new encryption key, as KDisk has been provided. If the user happens to lose the startup key, then only a hardware reset can be performed on the TPM. This reset, just like the software-triggered reset described earlier in this paragraph, will erase all keys and values inside the TPM, except for the endorsement key, and it will be possible to take ownership of the TPM again.

This procedure ensures that either the person disabling or resetting the TPM is the legitimate owner of the computer and thus has all the necessary information, or it will require that user to reset the TPM by hardware in order to change the TPM's internal state. Since TPM resets will clear all keys and values stored inside the TPM, except for the endorsement key, the data encrypted with KDisk will remain confidential as long as the malicious user cannot obtain that key. Of course, this should not happen so frequently, if the legitimate user follows the recommendation to keep the keys in separate and secure locations, preferably with KDisk away from the computer during everyday use.

Once the operations that required disabling or resetting the TPM have been performed, the TPM can be enabled again, which will trigger it to calculate a new HMAC value and also the KMaster key, just as described in the Enhanced Data Confidentiality Protocol (Table 3.5, continued in Table 3.6).

3.7.2 Multiple Users, the Pre-Boot Tokens and the Operating System Password

If the computer does not ask for a startup password, then a malicious user, who managed to obtain the startup token and the computer, could put confidentiality of the data at stake. The malicious user wouldn't even need to know KDisk, as the TPM would pass the Extended Pre-boot Validation Protocol, using the startup token, and provide access to the disk containing the operating system. The only way to avoid this is to have the Extended Pre-boot Validation Protocol ask the user for some input, which either translates in the user presenting some other token, thus decreasing the usability level of the solution, or by entering some password. The latter approach brings the present approach back to demanding that the user defines a startup password when executing the Enhanced Data Confidentiality Protocol, which highlights the importance of defining and using one.

PGP Whole Disk Encryption [68] proposes that the pre-boot authentication keys, i.e. the token, the password, or both, become synchronized with the Windows login password so that the user does not have to provide it after starting the computer. That proposal can reduce the usability impacts of the solution on the user, because the user does not have to memories another password, but it might also decrease the overall confidentiality threshold of the computer.

If a malicious user managed to get the computer, the startup token and the startup password, he would use them to start the computer. If the operating system did not require a login password, since it would be synchronized with the startup password, then full access to the data would be provided. If the two keys were not synchronized, the operating system login screen might still deter the least tech-savvy users, since they would not know the operating system user and password. However, that additional level of security could still be easily bypassed, if the attacker had some technical skills, as described in 2.4.1.

Another advantage of not using the proposal by PGP Whole Disk Encryption [68], i.e., by requiring that the user still enters a valid username and password to login into the system, is that the startup token and key can be easily duplicated if more than one person need to have access to the same computer, and it only requires copying some files. Considering the assumption that the legitimate user keeps the startup token in a secure location, it is easy to understand that duplications of this key or token can only occur if the legitimate user authorizes them, or if the legitimate user leaves them unattended and the malicious user can obtain them. If the proposal to have these elements synchronized was followed, the operating system would have to allow a user to create several startup tokens and keys, each and every one of them different from the others, so that they could then be synchronized with each user's login and password for the operating system. This would make the entire management process more complex, without further increasing the security of the system by the same amount.

3.7.3 Data Recovery

It is possible that a user, legitimate or not, attempts to connect the hard disk to another computer in order to obtain access to the data. This scenario could occur if the computer breaks down and the legitimate user plugs the hard disk into another computer in order to read the data, or if the malicious user sees that he cannot bypass the pre-boot validation sequence by the TPM in the stolen computer and tries to use another computer to get access to data. Whichever the situation, the user will only be able to recover the data by using KDisk directly to decrypt the data, so as long as this is not known by the malicious user, the data will remain confidential. As for the legitimate user, he would resort to the functionality provided by the TPM in the other computer, if one existed and after configuring it for that user, to attach an encrypted drive to the system and obtain access to the data using KDisk, or he would have to resort to some kind of disk encryption tool and provide KDisk so that it could decrypt the data.

3.7.4 Computer Decommission

Computer decommission is not really a problem and is, in fact, very easy to achieve as a side effect of this approach. The problem usually associated with computer decommissioning is that data can be retrieved from the hard disk of a decommissioned computer [71]. If the data in the disk is not encrypted, it would be possible for a third party to recover relevant data and misuse it at will. However, since this approach relies on whole-disk encryption to ensure data confidentiality, the decommissioning process is reduced to resetting the TPM, which will erase all keys, and securely disposing of KMaster and KDisk, which can easily be achieved by writing over it with gibberish data. Anyone that finds the hard disk will not be able to get the data from the inside, and the only operation left will be to completely wipe out the disk before it can be used again.

3.8 Denial of Service Attacks on the Data

Denial of service attacks are usually the ones harder to prevent. In the case of data, they are also hard to recover from. If the attacker replaces the disk by an empty one or completely destroys the disk, then there is not anything one can do to prevent these types of attacks, once the attacker has gained access to the computer. However, since those attackers are not the main target of this present approach, it is still possible to prevent some kinds of denial of service attacks.

If the attacker connects an encrypted disk to another computer, deletes the data inside and writes some random data over the deleted files, the original files cannot be recovered. Since the data is encrypted, it might be enough for an attacker to change some bits in the encrypted sectors of the disk and thus completely ruin the encrypted contents, even without knowing what he was destroying. In that scenario, if the legitimate user were able to recover the equipment, the corrupted data would not be of much use anymore.

In order to mitigate that kind of denial of service attacks, it is important that the disk encryption technique uses diffusion factors, so as to make it harder for an attacker to know which sector to attack in order to invalidate a specific file. This reduces the possible attacks to whole-disk denial of service attacks, in which the attacker would have to write over the entire contents of the disk. If the possibility of these kinds of attacks needs to be considered, then the hard disk could include its own TPM, which would run ADIP with the main TPM in the system. The user would, of course, have to take ownership of the disk's TPM, and this means the TPM owner password would have to be stored in a safe place. When the computer started, the main TPM and the disk TPM would validate each other, for example as part of the integrity checks performed during the pre-boot validation, and the hard disk would only allow access if it were in the same computer.

The main problem with this approach is that it prevents a legitimate user from connecting the disk to another computer to recover the data. In order to overcome that problem, the TPMs would generate a shared-secret and ask the user to store it in some storage media in a secure location. If the disk were connected to another computer and its TPM detected that the main TPM was not available, the TPM could ask the user for the TPM shared-secret in order to provide access to the disk. On providing the storage media with the shared-secret, the user would still be asked for KDisk, so that the contents of the disk could be decrypted. Even though this is not currently supported by TPM modules, the TPM specification [9] could be easily extended to provide such functionality.

While having the TPMs shared-secret, and the disk's TPM owner password together with KDisk, would not be a problem, it is once again not recommended, as it would reduce the confidentiality threshold of the system. If they were stored together, an attacker getting hold of KDisk would be able to have access to the data, just by connecting the disk to another machine and providing the shared secret. However, if they were stored in separate locations, for example storing the shared-secret and the disk's TPM owner password with the master TPM owner password, an attacker that manages to get the computer and KDisk would still not be able to get access to the data, and thus confidentiality would be ensured further.

3.9 Evaluation of the Approach

The protocols in the previous sections demanded that the user stored several information, and it was recommended to do it in different media. If it had not been like that, the security threshold of this solution would have been reduced. Table 3.9, continued in Table 3.10, depicts a summary of what the attacker can accomplish with each of the items that the protocols demand the user to store, as well as a comparison to other scenarios in which this solution is not used.

Those tables show why it is important to store the pieces of information, which the protocols ask the user to store, in different locations. In particular it shows that one must not store KDisk with the computer or with the startup token. In addition, one should not store the TPM owner password with the startup token either, as this would allow an attacker to reset the TPM, and thus destroy any keys or certificates inside that might be useful for the legitimate owner.

TABLE 3.9
Evaluation summary (I)

| If attacker gains access to: | The attacker can achieve: |
|---|---|
| Computer without any disk encryption | Access to all data by connecting the disk to another |
| | computer. |
| Computer with disk encryption installed | Access to all data by dumping the key from |
| and the operating system running | memory, and then using it to decrypt the contents. |
| Computer with TPM enforcing basic | Access to all data, limited if an operating system |
| confidentiality and basic pre-boot validation | login password is required and needs to be |
| Any combination of TPM owner key, | guessed, or if the attacker needs to exploit vulnerabilities |
| K_{Disk}, h₁ HMAC and s₂ signature | in the operating system, as the basic |
| | Pre-boot Validation Protocol allows the computer |
| | to start as long as no components have been tampered. |
| Computer with TPM enforcing enhanced | Access to all data, limited if an operating system |
| data confidentiality, by means | login password is required and needs to be |
| of token and pre-boot validation | guessed, or if the attacker needs to exploit vulnerabilities |
| Startup token | in the operating system, as the pre-boot |
| | validation will find the token, calculate the integrity |
| | checks over the components, and allow the computer |
| | to start. |
| Computer with TPM enforcing enhanced | No access to data, since the pre-boot process |
| data confidentiality, by means | would not continue unless the token were provided. |
| of token and pre-boot validation | |
| h₁ HMAC and s₂ signature | |
| Computer with TPM enforcing enhanced | Access to all data, limited if an operating system |
| data confidentiality, by means | login password is required and needs to be |
| of token, password, and pre-boot validation | guessed, or if the attacker needs to exploit vulnerabilities |
| Startup token, startup password | in the operating system, as the pre-boot |
| | validation will use the token and startup password, |
| | calculate the integrity checks over the components, |
| | and allow the computer to start. |
| Computer with TPM enforcing enhanced | No access to data, as the pre-boot validation |
| data confidentiality, by means | would not continue unless the user provided the |
| of token, password, and pre-boot validation | startup password. |
| Startup token, no startup password | |
| Any combination of TPM owner password, | |
| h₁ HMAC and s₂ signature, or | |
| odd bits of encrypting the disk encryption | |
| key | |

TABLE 3.10
Evaluation summary (II)

| If attacker gains access to: | The attacker can achieve: |
|---|---|
| Computer with TPM enforcing enhanced | Request the TPM to change the pre-boot validation |
| data confidentiality, by means | so that it does not ask for the startup token or |
| of token, password, and pre-boot validation | startup password. |
| TPM owner password | No access to data, since disk contents are encrypted |
| | by K_{Disk}, which is stored inside the TPM, |
| | and the TPM does not produce that key, even in |
| | the presence of TPM owner key. |
| Computer with TPM enforcing enhanced | Full access to data by expoiting the vulnerabilities |
| data confidentiality, by means | in the operating system. |
| of token, password, and pre-boot validation | |
| TPM owner password | |
| Operating system running | |
| Computer with TPM enforcing enhanced | Access to all data, by connecting the disk to another |
| data confidentiality, by means | computer and using K_{Disk} to decrypt the |
| of token, password, and pre-boot validation | disk contents |
| K_{Disk} | |
| Any combination of TPM owner password, | |
| h₁ HMAC and s₂ signature | |
| Computer with TPM enforcing enhanced | No access to data, as the TPM in the disk would |
| data confidentiality, by means | not allow the disk to start without the TPM shared- |
| of token, password, and pre-boot validation | key, even if the disk were connected to another |
| Hard disk with own TPM, sharing secret | computer. |
| key with master TPM | |
| K_{Disk} | |
| Any combination of TPM owner password, | |
| h₁ HMAC and s₂ signature | |
| Computer with TPM enforcing enhanced | No access to data, as the TPM in the disk would |
| data confidentiality, by means | ask to the TPM-shared key, and then for K_{Disk} in |
| of token, password, and pre-boot validation | order to decrypt the contents |
| Hard disk with own TPM, sharing secret | |
| key with master TPM | |
| TPM-shared key | |
| Any combination of TPM owner password, | |
| h₁ HMAC and s₂ signature | |
| Computer with TPM enforcing enhanced | Full access to data, as the TPM in the disk would |
| data confidentiality, by means | ask to the TPM-shared key, and then for K_{Disk} in |
| of token, password, and pre-boot validation | order to decrypt the contents |
| Hard disk with own TPM, sharing secret | |
| key with master TPM | |
| K_{Disk} and TPM-shared key | |
| Any combination of TPM owner password, | |
| h₁ HMAC and s₂ signature | |

### 4. Recovering Equipment and Data

When a computer is stolen or lost, its owner loses the equipment and all the data inside the computer could be lost forever as well. While disk encryption tools will help in keeping the data confidential, and prevent it from being misused, just as described in 2.4.2, there is nothing they can do in order to assist the owner in retrieving the contents of the computer. This data could easily be one's entire life: documents, contacts, songs, videos, photographs, etc., which are usually hard, or even impossible, to replace. The most common approach to recovering data, when a computer suffers an accident, is to resort to backup sets. If the computer is lost or stolen, backup sets are the only approach guaranteed to recover data. However, this approach is not flawless.

It is common knowledge that most people don't backup their data regularly, even though they know they should [4] and it is a process recommended by computer manufacturers and IT people. The reasons behind this problem could be several and the precise one is hard to identify by someone who backups regularly: it might be a complex process for most non-technical oriented users, it might require a change in processes and organization, it usually requires setting up different hardware, etc. Even if backup is done as an automatic process, just as it happens with Time Machine [72] on Macintosh computers running OS X Leopard, 2BrightSparks SynBackSE [73] or Iternum TrackMyFiles [74] on Windows computers, it still might not be used. It requires that an external hard drive is used and that some initial setup takes place, which could deter a large number of non-technical oriented users, even if the whole process is quite simple. This means that it is likely that a user does not have a backup set or, if one is available, it is very likely that it is not up to date. As a result, any data in the computer, or the data changed after the last backup operation, is lost with the computer if it is lost or stolen. Since the backup sets will not help in these scenarios, the only way to retrieve data from a misplaced computer is to return the equipment to its legitimate owner. The faster a computer is returned to its legitimate owner, the higher the probability of the data inside remaining useful. Therefore, it is of the utmost importance that the legitimate owners are able to get their equipment and their data back, as soon as possible, in case the computer has been misplaced.

4.1 State of the Art: Software Promises to Help

The need to recover a computer if it is lost or stolen is not new, so several products exist that promise to help the user with that task. There are commercial and open-source products that one can install into the computer, and they all promise to track the location of the equipment once it connects to the Internet. The author has not personally tested any of these products or their efficiency, but their websites, user manuals and alleged success stories provide enough information for one to understand their basic behavior.

Computrace LoJack [75] is a software program that one installs into one's computer and BIOS. It will contact a monitoring server when the computer is connected to the Internet, and use “information sent from the stolen computer to investigate, get evidence and assist local police” in recovering one's computer. It also allows a user to remotely delete all files in the hard disk.

GadgetTrak [76] is a utility for PC and Macintosh computers that will send an email when one's computer is found in a location different from an established set of accepted locations, based on the network environment information provided by the computer. This email includes network information about the location, ISP data and, in the case of Macintosh computers, data about all the wireless networks in the vicinity. The Macintosh application is also able to capture small videos (using the integrated iSight camera) of the person using one's computer, as well as displaying the owner's contact information, and blocking the computer after an amount of time has elapsed without the user entering a valid password. Regarding the PC application, the company says that “all communication is done silently in the background with no indication that the software is sending information” and that “removal of the hard drive will not remove the software”.

Undercover [77] is a similar Macintosh application that will periodically transmit network information, screen shots of what is being done with the computer, and also pictures of the person using it. If recovery fails, it can simulate a hardware failure, thus forcing the person using the computer to take it to an authorised service centre for repair, where it can be detected that it was misplaced and, hopefully, returned to the rightful owner. When one installs the program, one receives an Undercover ID, and it is required that one uses this ID in order to start the location process, which according to them, is for one's own privacy.

Dell's Laptop Tracking and Recovery Service [78] is a similar service, available to customers who purchase Dell equipment, which relies on an agent installed into the BIOS to send tracking information to a server whenever the computer connects to the Internet. It allows the user to perform remote data deletion and, according to Dell, it is designed in such a way that allows “the software agent to survive operating system re-installations, hard drive re-formats and even hard drive replacements”.

All these products or services require some software to be installed in the computer and in the BIOS, and they are not included by default with the computer, except for Dell's solution. So a user will have to install them explicitly, which means that most users will not do it. The reasons are very similar to the ones that prevent most users from using disk encryption or backup tools, and most of them have been addressed earlier in 2.4.2 and Chapter 3: they might be difficult to setup for non-technical users, users might be afraid of breaking something and losing their data, they might require a change in processes, users might even ignore that such tools exist, etc.

If these products need to be installed into a computer, they can certainly be removed. While it might be hard for a regular user to uninstall them, a user with more technical knowledge can probably disable these products without much effort. Even if part of the software is installed in the BIOS, the BIOS can be flashed and its contents erased, so it is possible to uninstall the software. In addition, some of these products claim to withstand operations that clear the contents of the hard disk, even if the disk is replaced by another one, and still report the location of the computer. This means that a user can lose irreplaceable data, but still be able to recover the equipment. This does not seem to make much sense, besides minimizing loss, in particular if one considers that it might be easier to have the computer protected by an insurance policy, which could also cover the value of the equipment if it got damaged.

There are a few issues about these solutions that one should take into account before considering to buy them, and a major one is privacy. GadgetTrak [76], for example, says that it will send an email when the computer is detected in a different location. While it can be used to locate malicious users, it can also be used against a legitimate user of the computer. In particular, how can an application detect a different location if it does not keep information about the previous one, so that it compares the two and detect they are different? The company states that they use “privacy-safe location tracking technology that does not rely on a monitoring center and protects your privacy”, which seems to contradict the part of detecting a different location, so can that claim be trusted?

More generally, none of these products reveals their protocols, so it is hard to ensure that they are not collecting and keeping location information even when the computer is not reported misplaced. This could be seen as a strong violation of privacy, and their claims of “silent” background communication, which is unnoticeable by the user, also do not help in increasing the trustworthiness of these products.

Another major issue with these products is that all of them require the computer to be connected to the Internet, in order to provide the location information. In order to connect to the Internet, the computer needs to be on, the operating system needs to be running, and an Internet connection needs to exist, either via an Ethernet cable, via a wireless network or via the internal modem, if one exists. Most people stealing a computer will not be using a dial-up modem, so the only real alternatives are Ethernet or Wi-Fi.

Being able to connect to the Internet means that it has already been possible to start the computer, and that an authorised account is being used to access the Internet. This means that it was either possible to login using a valid user or that there is a process running in the computer, with superuser privileges, which is able to access the Internet even before a user performs a login. If it was possible to login using a valid user, then access to any private data might have already been accomplished or might not be too far away. On the other hand, a process running with superuser privileges can execute all operations in the computer, so letting it have unrestricted access to the Internet would certainly expose the computer to higher threats. Whichever the case, the scenario is not very appealing.

In addition to this discussion about the computer being able to connect to the Internet, one has also to consider that a misplaced computer might never connect to the Internet. If the computer never connects to the Internet, or cannot obtain reliable information about the network where it is connected, then these services become useless and one will never be able to recover the equipment.

Since the equipment is in the hands of malicious users, one must never forget that the more time it is in their possession, the more damage they can do to the data inside or, if they manage to obtain access to the data, the damage that may cause on the owner of the data.

Adeona [79, 80] is an open-source application that can provide location information when the computer connects to the Internet, just as the commercial applications above. Since it is open-source and anyone can have a look at its code, it seems to solve most issues related to privacy in the other applications. Data is not sent to a central location, and cryptography is used to ensure that only the legitimate owner can understand the location of the computer. However, it suffers from the same problem of the others, as it requires the computer to connect to the Internet in order to be able to send the information of its IP, the network topology where it is connected, and location information.

The author has not found any product that does not rely on the computer being able to connect to the Internet, so this seems to be the common trend among products like these. While one can understand the need to have the computer connect to the Internet to say where it is, the author believes the way these vendors are doing might not be the most appropriate one. The second part of this work consists of a recoverability scheme that does not rely on the computer being able to connect to the Internet.

4.2 Additional Hardware to Bypass the Limitations

As explained in Section 4.1, one of the major issues about these products that can be used to locate and recover a misplaced computer, is that they rely on the computer establishing a connection to the Internet before they can operate. However, it is possible that the computer never connects to the Internet or, if it does, the information it provides might not be enough to understand where it is. Even if the computer manages to connect to the Internet, it is clear why data compromise is a possibility, so it would be very useful if a malicious user would not be able to access the computer contents. This can be achieved by following the present approach to obtain confidentiality by default, as described in Chapter 3.

In order to overcome such limitation, the author proposes to add a GPS receiver and an enhanced GSM/GPRS/UMTS module to the main circuit board of the computer. This GPS and GSM/GPRS/UMTS module, or GPS/GSM module for short, is powered by the computer's main power source, but it is also connected to an independent long-duration battery, which is recharged every time the computer is connected to the power grid. It is programmed to automatically and periodically turn itself on for a few minutes and then off. The independent battery ensures that the module can operate for a longer period, even if the main power source can not provide energy to the computer.

This GPS/GSM module could be built from scratch, but some vendors already provide OEM solutions that integrate both systems [81, 82], which are very small and cost only a few tens of Euros, so the present approach is to use and enhance them. For better accuracy and efficiency, this module could be A-GPS ready, i.e., it could be able to determine its location using the positioning service provided by the GSM network, and enhance it with the calculations performed with the measures provided by the GPS signal, but that is not mandatory.

Additionally, the author proposes the inclusion of a GPS/GSM antenna in computers, so that they can receive those signals more easily, even in urban and noisy environments. It is hard to get a lock on a GPS signal if the receiver is in a building with some floors above it, but it is expected that this problem can be mitigated by using a large enough antenna and resorting to A-GPS, if it is available, thus combining the GPS data with the GSM location information. Current laptops already share the screen mounting with wireless antennas, so that they have stronger reception of 802.11 signals, and the same concept could easily be adapted in order to include a GPS/GSM antenna. Current OEM antennas for GPS and GSM [83, 67] require up to 50 cm2, which is less than 10% of the area available in a 15.4″ screen. This means that these antennas could be enhanced in order to reuse the entire available area and provide a much better reception signal.

Since the frequencies used by GSM (850 MHz, 900 MHz, 1800 MHz and 1900 MHz bands) and UMTS (1700 MHz and 2100 MHz bands) are different from the GPS frequency (1575.42 MHz), and all of them are different from the ones used by wireless networks (2400 MHz band) [84], it would be possible to have all of them sharing the same antenna without electromagnetic interference. The only kind of interference that might affect this antenna would be produced by the CPU, and this could easily be reduced by redesigning the socket where the CPU fits to work as a Faraday cage [85]. The electromagnetic noise produced by the CPU would not be able to leave the cage and interfere with the other signals.

Once this new hardware is provided with the computer, some changes to the procedures described in Chapter 3 are still required, so that the new hardware can be used towards the goal.

4.3 First Step: Adding a GPS/GSM Module to the System

In addition to the steps described in Section 3.1, the manufacturer needs to include a GPS/GSM module in the computer's main circuit board. The new module needs to execute the Authorisation-Data Insertion Protocol [9] with the TPM, which will establish a shared-secret between the GPS/GSM module and the TPM. This shared-secret proves that the GPS/GSM module is authenticated and authorised to use the TPM API, and thus ask the TPM to perform operations.

4.4 Second Step: Operating System Installation

The operating system installation procedure is the same as described in Section 3.2 and does not need to be changed. It will consist of formatting the hard drive, if needed, performing the copies of the operating system files, setting up the hardware, configuring the minimum services required to boot the computer into the next step of the installation, and defining a login username and password for the operating system.

Since a GPS/GSM module has been added to the system, user programs can also use it, even though that is not its main purpose. In that scenario, the operating system would need the appropriate drivers for the GPS/GSM module, but these can be provided in a separate CD, that is shipped with the computer, and that the user can install later if desired.

4.5 Third Step: Taking Ownership of the Computer

The process of taking ownership of the computer is the same as described in Section 3.3 and detailed in Table 3.1. It consists of the user defining the TPM owner password, and being able to store it in some external media, and does not need to be changed.

4.6 Fourth Step: Activating Disk Encryption and Traceability

In order to be able to use the new GPS/GSM module in the system to locate a computer when it is reported stolen, the procedure from Table 3.5 (continued in Table 3.6) needs to be enhanced. The TPM needs to store an additional flag, which indicates if the computer has been reported as misplaced. The HMAC calculations need to take into account the new flag values, the firmware and serial numbers of the GPS/GSM module. During the process, the user is also asked to store some additional information, which the user will need to provide when the computer is misplaced. The flow of execution, which must be carried to achieve confidentiality and traceability, is depicted in Table 4.1, continued in Table 4.2 and in Table 4.3.

Similarly to the process of achieving enhanced data confidentiality, described in Table 3.5 (continued in Table 3.6), the process of achieving confidentiality and traceability starts with the generation of an encryption key, which is used to encrypt the disk, and continues by requiring the user to define a startup PIN or create a startup token. In addition to the flags about the PIN or token usage, there is now an additional flag, which controls if the computer has been reported stolen, the default value 0 meaning the computer is with the legitimate owner. The process continues with the TPM deriving KOwner from the TPM owner password.

The two HMAC calculations (h10 and h20) performed by the TPM (step 10), to ensure at boot time that no components have been tampered, are changed in order to include the firmware and the serial numbers of the GPS/GSM module. By including the GPS/GSM firmware and serial number into the HMAC calculations, one ensures that the pre-boot validation will only proceed if this module has not been tampered with. When there is the need to update the firmware on this module or to replace it, the user has to manually disable the TPM, by providing the TPM owner password, and, when the update is complete, the user needs to go through the process for achieving confidentiality and traceability again, except for the steps in which KDisk is generated and used to encrypt the disk, as these values can be provided by the user. That process allows the user to re-create the startup keys and tokens, after performing the appropriate HMAC calculations.

Once those calculations are performed, the TPM also calculates two other HMAC values (h11 and h21), which take almost the same input of h10 and h20, but replacing the stolen flag default value 0 with 1 (step 11), which indicates the computer has been reported stolen, without actually changing that flag. Then, the TPM signs each of the HMAC calculations with the private part of its endorsement key (step 12), storing the signatures of h10 and h11 (s10 and s11) in the TPM. The user is then asked to store the HMAC value h10, and the signatures s20 and s21 in an external device (step 13), so that they can be used later to detect and recover from disk errors.

TABLE 4.1
Achieving confidentiality and traceability protocol (upgrades from the
Enhanced Data Confidentiality Protocol in Tables 3.6 and 3.5, in bold)

| | | Actions | Description |
|---|---|---|---|
| 1. | OS → TPM | generateKey( ) | OS asks the TPM to generate an encryption |
| | | | key |
| 2. | TPM | K_{Disk} | TPM generates K_{Disk} |
| 3. | TPM | HD ← E (K_{Disk}, HD) | TPM encrypts the hard disk (HD), or the active |
| | | | partition if there is more than one, with K_{Disk} |
| | | | (leaving the Master Boot Record (MBR) unencrypted) |
| 4. | TPM → User | K_{Disk} | TPM asks user to store K_{Disk} in an external |
| | | | device |
| 5. | User → TPM | password | user optionality enters a password, pass |
| | | | phrase or PIN (referred simply as password in |
| | | | the subsequent steps) |
| 6. | User → TPM | useToken | user optionally chooses to have a token (referred |
| | | | as startup token in the remainder of this |
| | | | section) |
| 7. | TPM | flags | TPM stores a 2-bit value indicating if the user |
| | | | wants to use a password, a token or both |
| 8. | TPM | stolenFlag | TPM stores another flag (stolenFlag), which |
| | | | indicates if the computer was reported misplaced |
| | | | or not, with the default value of 0 indicating |
| | | | that the computer is with its legitimate |
| | | | owner |
| 9. | TPM | K_{Owner} ← | TPM retrieves the TPM owner password |
| | | f (TPM_{Owner}) | (TPM_{Owner}) stores inside the TPM |
| | | | TPM deterministically derives a key K_{Owner} |
| | | | from the TPM owner password TPM_{Owner} |
| 10. | TPM | M10 ← firm + | TPM calculates a SHA-1 HMAC, using |
| | | firmGPSGSM + | K_{Owner}, over the computer firmware |
| | | BIOS + flags + | (firm), GPS/GSM firmware(firmGPSGSM), |
| | | stolenFlag(0) + | BIOS (BIOS) and TPM flags (flags and |
| | | MBR + #TPM + | stolenFlags), the MBR (MBR) and the serial |
| | | #BIOS + | numbers of the TPM (#TPM), the |
| | | #GPSGSM | BIOS (#BIOS) and the GPS/GSM module |
| | | M20 ← firm + | (#GPSGSM): |
| | | firmGPSGSM + | if the user enters a password: using |
| | | BIOS + flags + | K_{Owner} XOR-ed with the input password |
| | | stolenFlag(0) + | else: using just K_{Owner} |
| | | #TPM + #BIOS + | TPM calculates a similar SHA-1 HMAC, using |
| | | #GPSGSM | K_{Owner}, over the same components, but |
| | | h₁₀ ← | excluding the MBR |
| | | HMAC(K_{Owner} [symbol] | |
| | | password, M10) | |
| | | h₂₀ ← | |
| | | HMAC(K_{Owner} [symbol] | |
| | | password, M20) | |

TABLE 4.2
Achieving confidentiality and traceability protocol (II) (upgrades from the
Enhanced Data Confidentiality Protocol in Tables 3.6 and 3.5, in bold)

| | | Actions | Description |
|---|---|---|---|
| 11. | TPM | M11 ← firm + | TPM calculated two other SHA-1 HMAC h₁₁ |
| | | firmGPSGSM + | and h₂₁, similar to h₁₀ and h₂₀, but using |
| | | BIOS + flags + | the value of 1 for the flag that indicates the |
| | | stolenFlag(1) + | computer was misplaced, without actually |
| | | MBR + #TPM + | changing that flag |
| | | #BIOS + | |
| | | #GPSGSM | |
| | | M21 ← firm + | |
| | | firmGPSGSM + | |
| | | BIOS + flags + | |
| | | stolenFlag(1) + | |
| | | #TPM + #BIOS + | |
| | | #GPSGSM | |
| | | h₁₁ ← | |
| | | HMAC(K_{Owner} [symbol] | |
| | | password, M11) | |
| | | h₂₁ ← | |
| | | HMAC(K_{Owner} [symbol] | |
| | | password, M21) | |
| 12. | TPM | s₁₀ ← S(Eₖᵣ, h₁₀) | TPM signs each of the HMAC values with |
| | | s₁₁ ← S(Eₖᵣ, h₁₁) | the private part of its endorsement key (Eₖᵣ), |
| | | s₂₀ ← S(Eₖᵣ, h₂₀) | and stores the resulting s₁₀ and s₁₁ value inside |
| | | s₂₁ ← S(Eₖᵣ, h₂₁) | the TPM |
| 13. | TPM → User | h₁₀, s₂₀, s₂₁ | TPM asks the user to store the HMAC h₁₀ |
| | | | value and the signatures s₂₀, s₂₁ in an external |
| | | | device |
| 14. | TPM | K_{GSM} ← fg(K_{Owner}) | TPM generates and stores another encryption |
| | | K_{Sig,GSM} ← | key K_{GSM} and a signature key |
| | | fgs(K_{Owner}) | pair K_{Sig,GSM}, both deterministically derived |
| | | | from K_{Owner}. |
| 15. | TPM | [symbol] ← | TPM encrypts h₁₀ with K_{GSM}, signs the |
| | | E (K_{GSM}, h₁₀) | resulting value with the private part of |
| | | SMSDATA ← | K_{Sig,GSM}, and concatenates the encrypted |
| | | [symbol] \|\| | part and the signature. |
| | | S (Kr_{Sig,GSM}, | |
| | | [symbol] ) | |
| 16. | TPM → User | FileR ← < | TPM asks user to store a file FileR containing: |
| | | SMSDATA \|\| | the SMSDATA value, K_{GSM}, and |
| | | K_{GSM} \|\| | the public part of K_{Sig,GSM} in an external |
| | | Ku_{Sig,GSM} > | device, which can be the same one used to |
| | | | store K_{Disk}; |
| 17. | TPM | K_{Master} ← g(h₁₀) | TPM generates another encryption key |
| | | | K_{Master}, deterministically derived from the |
| | | | HMAC value calculated earlier |
| 18. | TPM | [symbol] ← | TPM encrypts K_{Disk} with K_{Master} |
| | | E(K_{Master,}K_{Disk}) | |

TABLE 4.3
Achieving confidentiality and traceability protocol (III) (upgrades from the
Enhanced Data Confidentiality Protocol in Tables 3.6 and 3.5, in bold)

| | | Actions | Description |
|---|---|---|---|
| 19. | TPM | useToken? | if the user chooses to use a |
| | TPM → User | X1 ← odd ( [symbol] ) | token: |
| | | | TPM stores the even bits of |
| | | X2 ← even | the resulting value in the |
| | | ( [symbol] ) | TPM; |
| | | | TPM asks the user to store |
| | | | the odd bits of the resulting |
| | | | value, called the startup |
| | | | key, in a USB device, |
| | | | called the startup device: |
| | | | else TPM stores the resulting |
| | | | value in the TPM |
| 20. | TPM | K_{Master} ← NULL | TPM disposes of K_{Master} |

The TPM then uses KOwner to deterministically generate another encryption key KGSM and a signature key pair KSig.GSM (step 14). These keys are stored inside the TPM and will later be used by the traceability functionality, in order to locate a computer that has been reported stolen. Using these keys, the TPM encrypts h10 and then signs the resulting value. The encrypted h10 is concatenated with its signature (step 15), and the user is then asked to store the resulting token in some external device (step 16).

FileR from step 16 and KDisk can be stored in the same external storage or in different ones, depending on the user's will. If a malicious user gets hold of KDisk and knows how to use it to decrypt the data, then having FileR in the same external storage only provides the adversary with the possibility to flag that equipment as stolen, which is something he already knows. If he is intelligent enough to use KDisk to decrypt the data, possibly by using some other computer in the process, then it is fair to assume that he is also intelligent enough to reset the TPM and with that prevent the computer from sending further location information and being located. Thus, the presence or absence of FileR becomes irrelevant. On the other hand, if they are stored in different storage media, the likelihood of losing both is reduced, and it still might be possible for a user to retrieve his computer and obtain access to the data inside, if only KDisk is lost and assuming it is not lost together with the computer.

While storing FileR and KDisk values together or separated is almost irrelevant from a security point of view, the same is not entirely true for the startup token and FileR. If a malicious user gets hold of the computer and the startup token, then he has no use for FileR, which only allows him to flag the computer as stolen, and he can start the computer and have access to the data, unless a startup password is required. However, from a recoverability perspective, if they are kept together, the legitimate owner might no longer be able to flag the computer as stolen and will never get it back. It is up to the owner of the equipment to store FileR in a secure location and only use it if the computer is misplaced, but the least privilege argument presented in Section 3.4 also applies here.

The process ends with the TPM generating a master key, encrypting KDisk with that master key, and then storing the result wither inside the TPM or inside the TPM and in the user's startup token, following a secret-splitting approach similar to the one introduced in 3.4.2.

4.7 The Enhanced Pre-Boot Process

Since the process to obtain confidentiality and traceability is based on improvements to the process of achieving enhanced confidentiality, the pre-boot validation process also needs to be improved, to take into account the new operations that are required. The updated process is described in Table 4.4, continued in Table 4.5 and in Table 4.6. This process is mostly similar to the one described in Section 3.5, and starts with the TPM deriving KOwner from the TPM owner password. Then, the user is asked to provide the startup token or password, according to the information in the flags. If these inputs are not provided, then the pre-boot validation process stops and the computer does not start.

During the subsequent steps (step 3 and 4), the TPM calculates the same HMAC values that had been calculated during the Confidentiality and Traceability Protocol execution. These values are then signed with the private part of the TPM's endorsement key. Since that key is only known by the TPM, the signatures cannot be forged. Once these values are calculated, the s10. and s11. are compared with the s10 and s11 values stored inside the TPM (step 6). Recall that these values were sealed inside the TPM during the Confidentiality and Traceability Protocol execution, and that they were calculated from the same input, except for the flag that indicates the computer has been reported stolen.

If s10. matches the corresponding value stored inside the TPM, then no component in the computer has been changed, the computer has not been reported stolen and the pre-boot process can continue. However, if s10. does not match the stored counterpart but s11. does, then the computer has been reported stolen, the pre-boot process stops and the computer does not start.

If none of those values match, then it means that some of the components have been tampered or that a logical error in the risk has occurred. In order to mitigate the possibility of a logical error, the user is asked to enter the h10 HMAC value and the signatures s20 and s21, that were stored during the execution of the Confidentiality and Traceability Protocol (step 7). If the user cannot provide these inputs, the pre-boot process stops and the computer does not start. The s20 and s21 values are compared against the ones calculated by the TPM in step 5. Recall that these values were calculated using the same input as the s10 and s11, but without taking into account the MBR. If s20 matches, then a logical error has occurred and the computer can proceed.

In that scenario, the user provided h10 needs to be verified, so that it can be used to derive KMaster. The TPM signs that value with the private part of its endorsement key, and verifies if the signature matches the one previously calculated (step 9).

However, if s20 does not match but s21 matches, it means that the MBR has been changed and, more important, that the computer has been reported stolen. In that scenario, the pre-boot process stops and the computer is not allowed to continue booting.

If none of the signatures match, then the computer cannot start, as several components have been tampered, and the TPM does not know if the computer has been stolen or not.

Once a match with h10 has been obtained, either because the computer had not been tampered (step 3), or because the value provided by the user (step 7) is correct, then the TPM uses that value to derive KMaster and with it decrypt K!Disk, which it can then use to decrypt the contents of the disk and allow the operating system to continue the boot process.

TABLE 4.4
Enhanced Pre-boot Validation Protocol (upgrades from the Extended Pre-Boot
Validation Protocol in Tables 3.7 and 3.8, in bold)

| | | Actions | Description |
|---|---|---|---|
| 1. | TPM | K_{Owner} ← | TPM retrieves the TPM owner password |
| | | f (TPM_{Owner}) | (TPM_{Owner}) stored inside the TPM |
| | | | TPM deterministically derives a key K_{Owner} |
| | | | from the TPM owner password TPM_{Owner} |
| 2. | User → TPM | flags = | TPM retrieves the Flags value |
| | | useToken?, flags = | If the Flags say that a token, a boot password, |
| | | passwd? | or both are required, then they are provided by |
| | | token, password | the User |
| | | | Failure to provide these inputs causes the boot |
| | | | process to stop |
| 3. | TPM | M10′ ← firm + | TPM calculates a SHA-1 HMAC, using |
| | | firmGPSGSM + | K_{Owner}, over the compute firmware |
| | | BIOS + flags + | (firm), GPS/GSM firmware (firmGPSGSM), |
| | | stolenFlag(0) + | BIOS (BIOS) and TPM flags (flags and |
| | | MBR + #TPM + | stolenFlags), the MBR (MBR) and the serial |
| | | #BIOS + | numbers of the TPM (#TPM), the |
| | | #GPSGSM | BIOS (#BIOS) and the GPS/GSM module |
| | | M20′ ← firm + | (#GPSGSM): |
| | | firmGPSGSM + | if the user enters a password: using |
| | | BIOS + flags + | K_{Owner} XOR-ed with the input password |
| | | stolenFlag(0) + | else: using just K_{Owner} |
| | | #TPM + #BIOS + | TPM calculated a similar SHA-1 HMAC, using |
| | | #GPSGSM | K_{Owner}, over the same components, but |
| | | h_{10′} ← | excluding the MBR |
| | | HMAC(K_{Owner} [symbol] | |
| | | password, M10′) | |
| | | h_{20′} ← | |
| | | HMAC(K_{Owner} [symbol] | |
| | | password, M20′) | |
| 4. | TPM | M11′ ← firm + | TPM calculates two other SHA-1 HMAC h_{11′} |
| | | firmGPSGSM + | and H_{21′}, similar to h_{11′} and h_{20′}, but using |
| | | BIOS + flags + | the value of 1 for the flag that indicates the |
| | | stolenFlag(1) + | computer was misplaced, without actually |
| | | MBR + #TPM + | changing that flag |
| | | #BIOS + | |
| | | #GPSGSM | |
| | | M21′ ← firm + | |
| | | firmGPSGSM + | |
| | | BIOS + flags + | |
| | | stolenFlag(1) + | |
| | | #TPM + #BIOS + | |
| | | #GPSGSM | |
| | | h_{11′} ← | |
| | | HMAC(K_{Owner} [symbol] | |
| | | password, M11′) | |
| | | h_{21′} ← | |
| | | HMAC(K_{Owner} [symbol] | |
| | | password, M21′) | |

TABLE 4.5
Enhanced Pre-boot Validation Protocol (II) (upgrades from the Extended Pre-
Boot Validation Protocol in Tables 3.7 and 3.8, in bold)

| | | Actions | Description |
|---|---|---|---|
| 5. | TPM | s_{10′} ← S(Eₖᵣ, h_{10′}) | TPM signs each of the HMAC with the private |
| | | s_{11′} ← S(Eₖᵣ, h_{11′}) | part of its endorsement key |
| | | s_{20′} ← S(Eₖᵣ, h_{20′}) | |
| | | s_{21′} ← S(Eₖᵣ, h_{21′}) | |
| 6. | TPM | s₁₀ = s_{10′}? | TPM retrieves the signatures of the HMAC |
| | | s₁₁ = s_{11′}? | values stored inside the TPM, which were |
| | | | calculated during the confidentiality and |
| | | | traceability protocol |
| | | | TPM compares the calculated value s_{10′} |
| | | | with the stored value s₁₀. If no component in |
| | | | the computer has been changed, then these |
| | | | values will match, and the computer continues |
| | | | this flow in step 10. |
| | | | If s_{10′} does not match the stored value, TPM |
| | | | compares the calculated valeye s_{11′} with the |
| | | | stored value s₁₁. If they match, then no component |
| | | | in the computer has been changed, |
| | | | but the computer has been reported stolen |
| | | | and the pre-boot process stops. |
| 7. | User → TPM | h₁₀, s₂₀, s₂₁ | TPM asks the user to provide the h₁₀ HMAC |
| | | | value and the signatures s₂₀ and s₂₁, that |
| | | | were stored during the execution of the confidentiality |
| | | | and traceability protocol |
| | | | If the user cannot provide that information, |
| | | | the boot process is stopped, the computer |
| | | | does not load the operating system, and the |
| | | | subsequent steps are not performed |
| 8. | TPM | s_{20′} = s₂₀? | TPM compares the user provided value s_{20′} |
| | | s_{21′} = s₂₁? | with the calculated value s₂₀. If these do |
| | | | not match, then the signatures do not verify, |
| | | | the boot process is stopped, and the subsequent |
| | | | steps are not performed |
| | | | If s_{20′} does not match the stored value, |
| | | | TPM compares the calculated values s_{21′} with |
| | | | the stored value s₂₁. If they match, then the |
| | | | computer has been reported stolen and the |
| | | | pre-boot process stops. |
| 9. | TPM | s_{10″} = S(h₁₀) | TPM signs the HMAC provided by the user |
| | | s_{10″} = s₁₀? | with the private part of its endorsement key |
| | | | TPM compares the signature s_{10″} with |
| | | | the stored value s₁₀. If it matches then |
| | | | the HMAC provided by the user has not |
| | | | been tampered and can be used to calculate |
| | | | K_{Master}. If they do not match, then the booting |
| | | | process is stopped and the subsequent |
| | | | steps are not performed. |

TABLE 4.6
Enhanced Pre-boot Validation Protocol (III) (upgrades from the Extended
Pre-Boot Validation Protocol in Tables 3.7 and 3.8, in bold)

| | | Actions | Description |
|---|---|---|---|
| 10. | TPM | K_{Master} ← g(h₁₀) | TPM generates another encryption key |
| | | | K_{Master}, deterministically derived from h₁₀ |
| 11. | TPM | K_{Disk} ← | TPM uses K_{Master} to decrypt [symbol] stored |
| | | D (K_{Master}, | inside the TPM |
| | | [symbol] ) | |
| 12. | TPM | HD ← | TPM uses K_{Disk} to decrypt the hard disk |
| | | D (K_{Disk}, [symbol] ) | [symbol] , disposes of K_{Master}, and allows the |
| | | K_{Master} ← NULL | operating system to start executing |

4.8 Using the Computer

If the computer is never reported misplaced, it will continue to operate normally. The user will provide the startup token and password, and the TPM will execute the Enhanced Pre-boot Validation Protocol before the operating system is loaded.

The GPS/GSM unit will periodically (example, every 30 minutes) turn itself on and try to register with the cell network. If the module cannot obtain a cellular signal after a few minutes, the unit shuts itself down and retries a few minutes later. While the unit is on, it will receive any messages that are pending on the network and, in doing so, detect messages that report the equipment was misplaced. As described in Section 2.2, registering with the network and receiving any pending messages should take a few minutes at most.

4.9 Reporting and Locating Misplaced Equipment

When the computer is misplaced, it is up to the legitimate user to report it and trigger the process of locating the equipment. In order to do so, the user goes to a well known website, registers with a username and password, or uses a special application if the tracking service is installed locally, as described later. The user then enters the number of the SIM card inside the equipment and provides FileR. The server, or the application, reads FileR, recovers the information inside and stores it in association with the user data and the SIM card number: the SMSDAT A value calculated in step 15 of Table 4.2, KGSM and the public part of KSig.GSM.

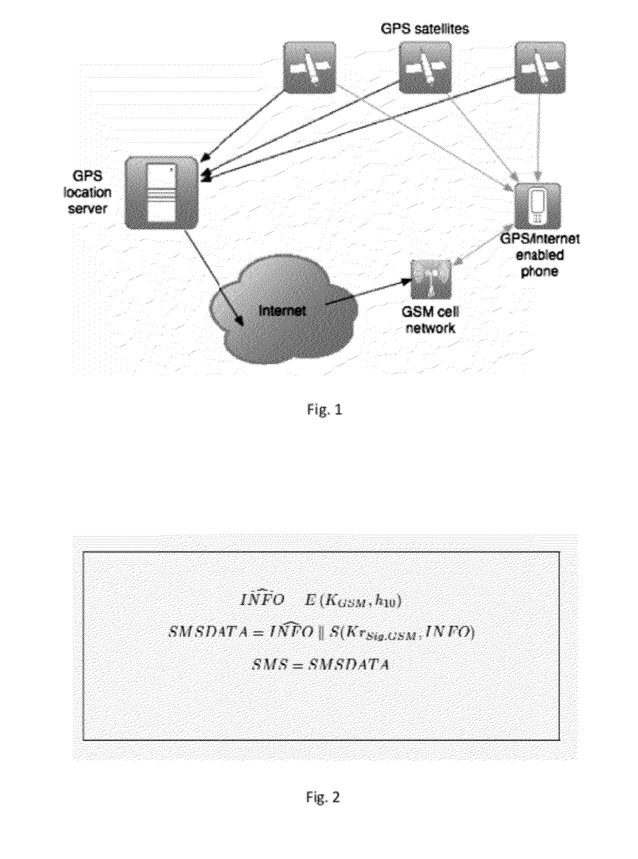

Since FileR contains the SMSDAT A value that was calculated by the TPM and that needs to be sent to the device, the server does not need to perform any cryptographic operations at this time. So, the server inserts the SMSDAT A value into a message and sends it via a GSM gateway, using the Short Message Service, to the number provided by the user, so that it can be delivered, over the GSM network, to the misplaced computer. The SMS contents are described in FIG. 2.

Once the GPS/GSM module receives that message, it will remove the GSM specific headers and provide the contents to the TPM. The SMS contents include the signature of INFO using the private part of KSig.GSM, to thwart malicious users from conducting GSM-based denial of service attacks against a TPM. When the message arrives, the TPM can use the public part of KSig.GSM and verify the signature, and if the signature verifies, it knows that the INFO part has not been tampered, because only the TPM would be able to have signed it using the private part of KSig.GSM. Since signature verification is usually computationally less expensive than decryption, if the verification of the signature fails, then the TPM does not perform the decryption.

If the signature over INFO does not verify, then the h10 calculation may have been tampered, which could mean that the server might have been compromised as well. Therefore, the TPM cannot decide if the message is really aimed at that computer and, as a consequence, if the equipment really was misplaced or not. In this scenario, the TPM will ignore this message. This ensures that only the subject holding FileR could have sent the message saying the computer was misplaced. This approach prevents a malicious user from locking out a legitimate user, in a very remote scenario, by capturing KGSM and trying to forge a special message so as to fool the TPM into believing the computer was stolen when it was not.

Inside the INFO part of the message, there will be h10 encrypted with KGSM. Both the TPM and the server have KGSM, but if h10 had not been created by the TPM, it would not have been possible to sign it with the private part of KSig.GSM, which is only known by the TPM, and the initial signature verification would fail. This ensures that the message is really aimed at the destination computer and that the h10 calculation has not been tampered since it was performed by the TPM, because only the TPM would be able to produce a valid signature over it. The TPM then uses KGSM, decrypts INFO, signs h10 with the private part of its endorsement key, and verifies if the resulting value s10 matches the one stored inside the TPM. Recall that s10 was stored inside the TPM during the confidentiality and traceability protocol.

If the above verifications are successful, the TPM knows that the equipment was misplaced. It sets the “misplaced” flag to active, and at the same time asks the GPS/GSM module to enter the beacon mode and calculate the location of the equipment.

In order for the GPS/GSM module to use the TPM, the TPM needs to be able to receive power from the computer's power source, even if the computer is turned off. It should also be connected to the same independent power supply that provides energy to the GPS/GSM module, which it will only use if the main power supply is not available. By following this approach, it is ensured that the computer is able to receive “misplaced equipment” messages and to send location information even if it is off, if it is not plugged to the power grid, or if the internal battery is empty, for a longer period.

4.9.1 The GPS/GSM Beacon Mode

Once the GPS/GSM enters the beacon mode, it will very frequently (e.g., every few minutes) calculate its position and send it to the tracking server via the GSM network. If the GPS/GSM module is A-GPS compatible, it contacts the cellular network base station and obtains its approximate location, as described in 2.3.2. It starts listening to the GPS satellites and is able to determine the position of the computer. If the module is A-GPS ready, then this position calculation can be performed in a smaller interval and in noisier environments. If the module is not able to calculate a position after some minutes, it will send only the GSM-based location information, and try to provide GPS location in the next iteration of the beacon.

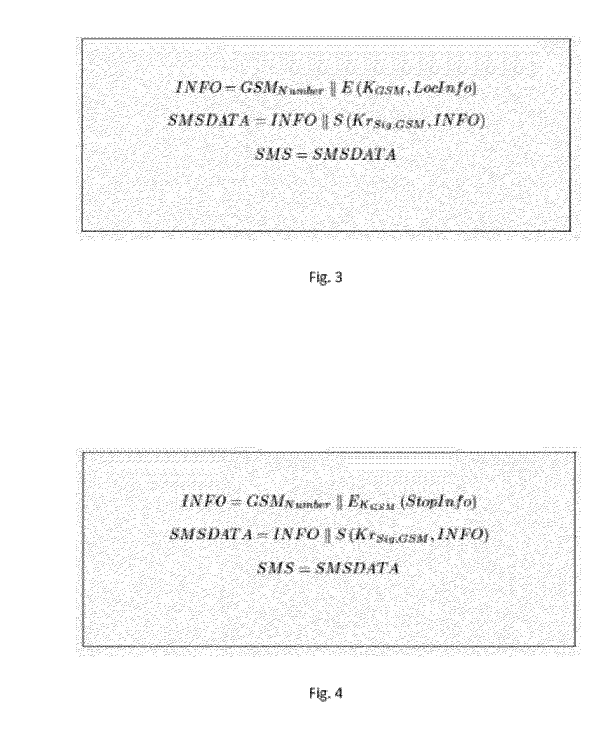

Once the GPS/GSM module has calculated a position, it asks the TPM to encrypt it using KGSM and to produce an INFO token consisting of the GSM number concatenated with the encrypted location information. The TPM then signs this INFO token with the private part of KSig.GSM, concatenates that signature to the INFO token and sends it to the GPS/GSM module, which will enclose it in a message. The message is then sent over the cellular network towards the gateway and the tracking server. The message contents sent in each beacon iteration are shown in FIG. 3. Once again, this process thwarts GSM-based denial of service attacks against the server, by ensuring that it only performs a decrypt operation if the signature of the encrypted part verifies. When the tracking server receives such message, it verifies if the origin number, available in clear text in the INFO part of the message, is in the database. If the number is in the database, meaning that the equipment is being tracked, the server then uses the associated public part of KSig.GSM and verifies the signature over the INFO part of the message. If the signature verifies, then the package has not been tampered, and can only have been generated by the TPM, as only it would be able to sign it using the private part of KSig.GSM.

The server decrypts the LocInfo part of the message, using KGSM, and adds the location information to the database. It immediately notifies any interested parties, such as the owner of the equipment and the police forces, providing them with the latest known location of the computer.

4.9.2 The Misplaced Computer

Once the computer has been reported misplaced and the TPM has marked the “misplaced” flag as active, the computer will no longer be usable, as the Enhanced Pre-Boot Validation Protocol will always fail. The HMAC calculations, and their signatures, described in steps 3-5 of the Enhanced Pre-boot Validation Protocol (Table 4.4, continued in Table 4.5 and in Table 4.6) will no longer match the corresponding values stored inside the TPM and thus it will stop the boot process. This ensures that the data in the computer remains confidential and that the computer is traceable. Since the GPS/GSM module is continuously sending the beacon signal, it is just a matter of time until the equipment can be located and, eventually, returned to the legitimate owner. If the computer cannot be located before the GPS/GSM unit runs out of power, then it will eventually be detected when the malicious user takes it for repair, since it is not working. Since the computer is not working, the legitimate user will still not be able to use it once it is returned. However, assuming that the recommendations to store the TPM owner password and KDisk in secure locations are followed, the user should have all the data that is required to change the state of the TPM and re-enabling the computer to be used. In particular, the user should have the TPM owner password that allows changes to the TPM to be done, and KDisk that provides access to the data inside the disk.

In order to reuse the computer again, the legitimate user needs to clear the “misplaced” flag that prevents the computer from starting. To change that flag, the user needs to enter the TPM owner password. If the TPM owner password cannot be provided, then an equivalent approach to the one described in 3.7.1 needs to be followed, in order to reset the TPM. Then, the user needs to go through the process for achieving Confidentiality and Traceability again (Section 4.6), except for the steps in which KDisk is generated and used to encrypt the disk, as these values can be provided by the user. That process allows the user to re-create the startup keys and tokens, after performing the appropriate HMAC calculations.

Once this process is being executed and before any new keys are generated, the TPM instructs the GPS/GSM module to exit from beacon mode, which will prevent it from sending further location information. The GPS/GSM module prepares one last message, which instructs the server to mark the computer as recovered and stop processing and storing location information messages associated with that number. This procedure ensures that a malicious user who managed to capture some location information messages will not be able to replay them against the server, thus mitigating the chance for a denial of service attack by exhaustion of server resources.

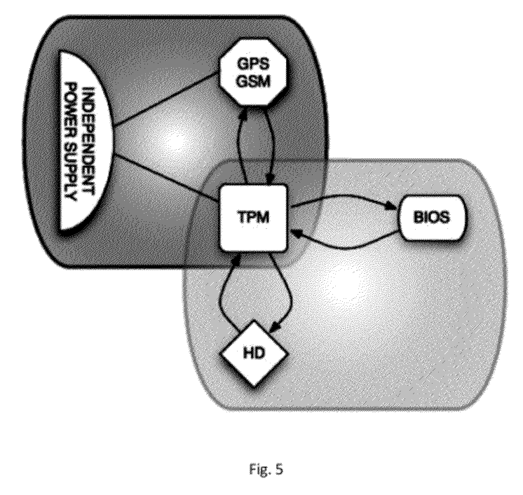

This message consists of a “STOP” instruction, which the GPS/GSM module asks the TPM to encrypt using KGSM, and the TPM then produces a INFO token consisting of the GSM number concatenated with the encrypted information. The TPM signs this INFO token with the private part of KSig.GSM, concatenates that signature to the INFO token and sends it to the GPS/GSM module, which will enclose it in a message. The message is then sent over the cellular network towards a GSM gateway and the tracking server. The message contents sent in each beacon iteration are shown in FIG. 4.

Just as with the SMS in FIG. 3, this process thwarts GSM-based denial of service attacks against the server, by ensuring that it only performs a decrypt operation if the signature of the encrypted part verifies. If the signature verifies, the server decrypts the StopInfo part of the message, and updates the information in the database.

Once the GPS/GSM module sends the message and exits the beacon mode, it will remain like that forever or until the computer is reported stolen again. The GPS/GSM module will revert to its original operation mode, in which it periodically turns on and connects to the network, just to check if any messages exist that report the equipment stolen.

4.10 The Importance of Using KSig.GSM

In the previous sections, the private and public parts of KSig.GSM have been used for signing and for verifying signatures on messages that are exchanged between the GPS/GSM module and the server. That process ensures that they were produced by the TPM and not tampered along the way. While the same operations could also be performed using the TPM's endorsement key (EK), using a different key brings some advantages and mitigates some possible replay attacks.

While EK is generated by the manufacturer and cannot be changed even if the TPM is reset, KSig.GSM is generated every time the traceability of the computer is activated, as described in Section 4.6. This means that a new KSig.GSM could be generated every time the process is executed, for example by taking into account an approach similar to a monotonic counter [10] randomly initialized when the TPM's ownership was first taken. This process results in different messages between the GPS/GSM module and the tracking server if the computer is stolen more than once, which prevents a malicious user who had previously captured the “STOP” message from replaying it and preventing the server from keeping further location information.

Since EK is not changeable, this property would not be achieved as easily if it were used to sign the messages between the GPS/GSM module and the tracking server.

4.11 Mitigating Attacks from Hardware Resets of the TPM

Since the TPM is used by the GPS/GSM module to send location information, resetting the TPM, as described in 3.7.1, would immediately prevent the location of the equipment. It would also impair the functionality of most of the protocols described in this present approach. Therefore, it is important that only the right person is able to reset the TPM, with the right person being the computer's owner or the manufacturer working on his behalf. In order to do so, the TPM firmware needs to be changed, so that only authorised people can reset the TPM. The reset command by software already requires the user to enter the TPM owner password, so only the person who knows it will be able to reset the TPM. If the owner of the computer has not stored that key with the computer, then the TPM cannot be reset by software. However, the hard reset does not ask for any special credentials, and anyone can reset the TPM.

Only the manufacturer, its legal representatives or its authorised personnel, should be able to perform a hardware reset on the TPM, and it should involve entering a password only the manufacturer knows, which is dependent on the TPM's serial number and manufacturer. The operation would consist of a physical part, just as it is done today to reset the TPM by hardware, but it would only be completed if, after doing the hardware operations, the user would enter the manufacturer password. While doing this ensures that the TPM is not reset by unauthorized people, it also makes it harder for a legitimate owner to transfer the ownership of the computer, or to get access to it if he happens to lose the TPM owner password. The assumption is that the legitimate user stores the TPM owner password in a secure location, so those scenarios should not hold very often. If they do, then the user would have to provide proof of ownership, so that the manufacturer would be able to reset the TPM.

In order to ensure the privacy of the end-user, every time the TPM is reset, the GPS/GSM beacon signal must be disabled, if it is enabled. At this time it will also inform the tracking server with the “STOP” message, just as described in 4.9.2, so that it does no longer store further location information about that device.

4.12 Evaluation of the Approach

Just as it had been described in Section 3.9, the protocols in this section require the user to store additional information, and it is recommended that this be done using distinct external devices. In particular, that sections shows that one must not store KDisk with the computer or with the startup token, and one should not store the TPM owner password with the startup token either, as this would allow an attacker to reset the TPM, and thus destroy any keys or certificates inside that might be useful for the legitimate owner.

TABLE 4.7
Evaluation summary (I)

| If attacker gains access to: | The attacker can achieve: |
|---|---|
| FileR | Try and guess the number of the SIM card inside |
| | the computer and flag it has stolen, causing |
| | a denial of service on the legitimate user |
| Computer with confidentiality and | No access to data, since the pre-boot process |
| traceability protocol active | would not continue unless the startup token and |
| Any combination of TPM owner password, | password were provided. |
| FileR, h₁₀ HMAC, s₂₀ and s₂₁ | |
| signatures | |
| Computer with confidentiality and | No access to data, since the pre-boot process |
| traceability protocol active | would not continue unless the startup password |
| Startup token | were provided. |
| Any combination of TPM owner password, | |
| FileR, h₁₀ HMAC, s₂₀ and s₂₁ | |
| signatures | |
| Computer with confidentiality and | Access to all data, limited if an operating system |
| traceability protocol active | login password is required and needs to be |
| Startup token and startup password | guessed, or if the attacker needs to exploit vulnerabilities |
| Any combination of FileR, h₁₀ HMAC, | in the operating system, as the enhanced |
| s₂₀ and s₂₁ | Pre-boot Validation Protocol allows the computer |
| | to start as long as no components have been tampered. |
| Computer with confidentiality and | No access to data, since disk contents are encrypted |
| traceability protocol active | by K_{Disk}, which is stored inside the TPM, |
| Startup token and startup password | and the TPM does not produce that key, even in |
| TPM owner password | the presence of TPM owner key. |
| Any combination of FileR, h₁₀ HMAC, | Reset TPM, disable traceability |
| s₂₀ and s₂₁ | |
| Computer with confidentiality and | Access to all data, by connecting the disk to another |
| traceability protocol active | computer and using K_{Disk} to decrypt the |
| K_{Disk} | disk contents (unless the disk itself has a TPM |
| Any combination of TPM owner password, | and that TPM shares a secret with the Master |
| FileR, h₁₀ HMAC, s₂₀ and s₂₁ | TPM) |
| Computer with confidentiality and | No access to data, as the TPM in the disk would |
| traceability protocol active | not allow the disk to start without the TPM shared- |
| Hard disk with own TPM, sharing secret | key, even if the disk were connected to another |
| key with master TPM | computer. |
| K_{Disk} | |
| Any combination of TPM owner password, | |
| FileR, h₁₀ HMAC, s₂₀ and s₂₁ | |

TABLE 4.8
Evaluation summary (II)

| If attacker gains access to: | The attacker can achieve: |
|---|---|
| Computer with confidentiality and | No access to data, as the |
| traceability protocol active | TPM in the disk would not |
| Hard disk with own TPM, sharing secret | allow the disk to start |
| key with master TPM | wthout the TPM shared- |
| TPM-shared key | key, and then for K_{Disk} in |
| Any combination of TPM owner password, | order to decrypt the |
| FileR, h₁₀ HMAC, s₂₀ and s₂₁ | contents. |
| Computer with confidentiality and | Full access to data, as the |
| traceability protocol active | TPM in the disk would ask |
| Hard disk with own TPM, sharing secret | for the TPM-shared key, |
| key with master TPM | and then for K_{Disk} in order |
| K_{Disk} and TPM-shared key | to decrypt the contents |
| Any combination of TPM owner password, | |
| FileR, h₁₀ HMAC, s₂₀ and s₂₁ | |

Table 4.7, continued in Table 4.8, depicts a summary of the possible scenarios after following all the recommendations in the previous sections. These scenarios comprise the TPM owner password, KDisk, FileR, the startup token, and the HMAC values and their signatures, stored during the confidentiality and traceability protocol.

### 5. Architecture of the Solution

The previous chapters have shown which functionality is involved in this present approach, how it works and what it can do. This functionality is split between computer and servers, and this chapter provides an overall view of how all the functionality fits and works together.

5.1 Computing Device Agent

In order to provide the required functionality, the computing device needs to include a TPM and a GPS/GSM module, which are powered by the regular power supply and also by a long-duration independent one. The independent power supply is rechargeable when the computer is connected to the power grid. This setup ensures that the GPS/GSM module will be able to detect that the computer has been stolen and provide location information, even if the computer is turned off, for a longer period. As an example, cell phone batteries already last for several hundred hours, so a similar approach could be used to power these two components, ensuring that the computer would be able to produce location information for a long time after it has been misplaced. This would increase the probability of finding the equipment sooner.

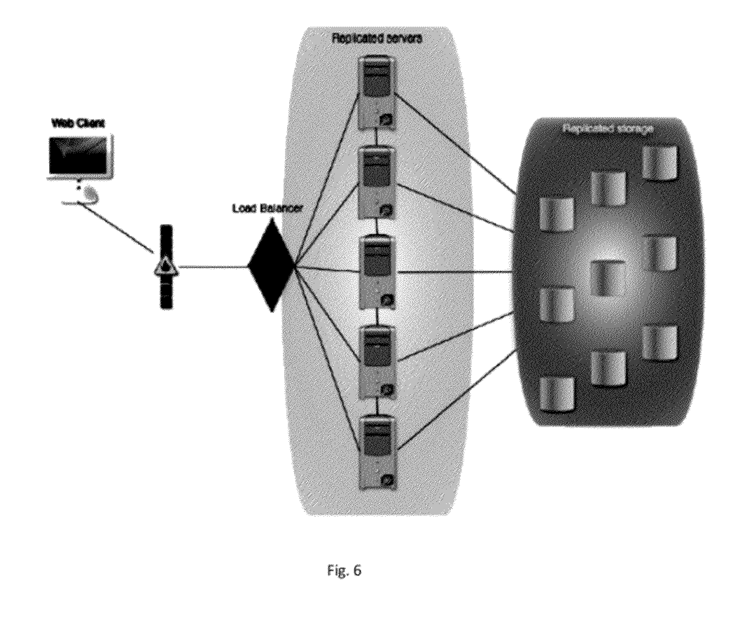

FIG. 5 on depicts a very simple diagram of the components working together, with the darker area on the left area representing the components responsible for ensuring the traceability of the computer, and the lighter area on the right area containing the components in charge of data confidentiality. The diagram does not show the main power supply of the computer, but one will, of course, exist and all components will be connected to that power source.

The TPM will interact with the Hard Disk and the BIOS to ensure confidentiality of the data, by resorting to whole-disk encryption and asking for the startup token and password from the user. In addition, the TPM also interacts with the GPS/GSM module in order to receive the notification that the computer has been reported misplaced and to provide location information.

In order for these components to operate with the TPM, they need to run the Authorisation-Data Insertion Protocol together with the TPM, so that a secure channel can be established between them. This protocol is executed when the computer's circuit board is being assembled. When the operating system is finalizing the installation, the ownership procedure is carried by the computer owner, in which the TPM owner password, the disk encryption key, the information to use when recovering the computer and the startup tokens are generated. If the operating system is pre-installed by the manufacturer, this operation is performed as the end user terminates the installation of the operating system, after he is asked to create a username/password pair and define some regional settings.

The information required to recover the computer is protected by cryptography and digital signatures. This ensures that only the legitimate user is able to report the computer as misplaced and to receive the information about its position, while at the same time ensuring the authenticity and integrity of the messages exchanged, and mitigating some GSM-based denial of service attacks. The TPM always signs information it sends to the server, and it always verifies its own signature in information received from the server.

In addition to the TPM and GPS/GSM components, the computing device should also include a combined GPS/GSM antenna. It shares the screen mounting of the computer and, since it can take the whole area of the screen, it would allow the computer to receive GSM and GPS signals even in very busy and noisy environments. This would of course increase the chances of the computer reporting its position and the chances of getting it back.

Once the computer is reported as misplaced, the GPS/GSM unit will continuously send location information and the TPM inside the computer will deny access to the computer and prevent it from being used, forcing the illegitimate owner to take it to a repair centre. At that point, only the legitimate owner can make the computer work again by providing the TPM owner password, or the TPM has to be reset by the manufacturer after the legitimate owner has shown proof of ownership. When the computer is recovered, the GPS/GSM stops working as a beacon, and no more location information is provided to the server, ensuring the user's privacy.

5.2 Server

The tracking server is an important part of this present approach, because it receives the information that allows one to locate the misplaced equipment. When a user needs to report a misplaced computer, the server will ask the user for the file with information needed to track the computer, and also for the GSM number of the SIM card inside the computer. Once the server receives the file, it obtains a token that allows it to tell the TPM that the computer was reported as misplaced, the cryptographic key the TPM will use to encrypt location data and a key that it can use to verify the data was generated by the TPM. That token is then sent to the computing device via the GSM network.

On receiving such token, the computing device will demand that the TPM verifies that its signature is valid, in which case it will ask the GPS/GSM module to start sending location information. Those keys are never used by the server for encrypting or signing anything, as all such operations are performed by the TPM inside the user's computing device.

When a message containing location information arrives at the server, the message signature is verified using the key recovered from the file and, only if the signature is valid, does the server decrypt it. The location information is then stored by the server or forwarded to the user, for example by email.

Once the computer is recovered, the server will receive one last message from the device that will instruct the server to stop storing any more location information. This prevents any malicious user, who managed to capture the previous location information messages, from sending them to the server again and overloading it with their processing.

There are two major scenarios that need to be taken into account when considering the server deployment: peer-to-peer and centralized management, which are described in the following sections.

5.2.1 Peer-to-Peer Model

The peer-to-peer model is probably the least expensive way of setting up the required server and is useful for home users who want to protect their equipment. They can setup a server to run on their home or office desktop, and they only need to connect it to the Internet and assign it an address. That computer does not even need to have a fixed public IP address, which is usually expensive to obtain, as the user can resort to dynamic DNS solutions, such as No-IP [86] or DNSexit [87].

Of course, that desktop computer has to be protected with firewalls and antivirus, as it is connected to the Internet. It runs a server application that the user only activates in case he needs to track some lost or stolen computer. When the stolen computer sends a message, it does so to that server application. That application retrieves the data required to trigger the location process and to receive, verify and decrypt the location information.

It then sends the location token to the computing device, using the GSM gateway of the network operator of the SIM card inside the stolen or lost computer. On receiving the messages with the location information, the GSM gateway forwards them to the address of the home server, which then verifies their signatures and decrypts them, providing the user with the location information.

5.2.2 Centralized Management

The centralized management model is suitable for large corporations that want to track many computers and wish to deploy their own tracking server, or for companies that want to provide this as an outsourced service to other enterprises. In this scenario, it is very important that the servers present a fault-tolerant architecture, based on replication, so that the availability of the system is ensured even if one or more replicas fail.

In order to use these services, a user goes to a webpage and registers his username and password. At this time, the user provides a file with information that the server will need to use in order to track the computer, and also the GSM number of the SIM card inside the computer. All these operations are performed over HTTPS, to ensure the confidentiality of the entire process. On receiving such information, the server can trigger the location process, by sending the token to the mobile device. It can then store the location information when the messages from the device arrive, after they have been forwarded by the GSM gateway. In order to do this, the server needs to verify the messages signatures and decrypt them, using the keys provided by the user.

Since these servers are available on the Internet and store interesting data, they are subject to a larger number of threats. Therefore, the basic architecture needs to include firewalls to limit the ports and services that are accessible on the servers, as well as intrusion detection systems (IDS), so that intrusion attempts can be detected and handled in the appropriate way, e.g. by changing firewall rules.

A simple crash-failure model, in which f+1 computers exist and up to f may be failed at the same time, is not enough for this system, because these servers need to calculate values and it would be possible that the only working server did not calculate the correct value. In order to overcome that limitation and prevent an invalid value from being calculated, a 2f+1 approach could be used, with up to f servers being allowed to crash or calculate a wrong value at the same time. However, that approach is still not enough, because there is a possibility that these servers start behaving incorrectly, either because an algorithm didn't produce the expected result or because the server has been compromised by an attacker. So, the servers in this scenario need to handle Byzantine failures, i.e., there must be at least 3f+1 servers, allowing up to f failed at the same time, and they must be able to continue operation and produce correct results even if f of them start behaving arbitrarily.

Castro and Liskov [88] have described an algorithm for replication that tolerates Byzantine faults, and a similar approach should be followed here, having the servers connected to each other, and each of them running their own operating system on different hardware. Diversification of the hardware and operating system ensures that it is harder for an attacker to compromise the system, as he will have to find vulnerabilities in different systems, and use different kinds of exploits. Thus, it will take him a longer time to compromise enough replicas, and this will give defense mechanisms more time to detect him and react.

FIG. 6 presents a very simple diagram of the server architecture.

When a message containing location information arrives at the server, the load balancer replicates the message to all servers. The replicas will then exchange messages between them and when each of them knows that f other replicas propose the same outcome as itself, then the operation can proceed, because at most f replicas can fail at the same time and f+1 equal answers means that no replica in that f+1 set is failed.

The message signature is verified using the key recovered from the file and, only if the signature is valid, does the server decrypt it. The location information is then stored in the database. The data to store is replicated across storage servers, using a fragmentation, randomization and scattering approach, which ensures that no one compromising one or more storage locations, but not all of them, would be able to understand the data. If someone were to compromise one of such servers, then he would only be able to recover some fragments of the information, which are meaningless on their own.

As an optimization to the server architecture, if the replicas all had a TPM and used some kind of wormhole network, then an approach similar to what is described by Veronese et al. [15] would reduce the number of replicas to 2f+1. The TPM functionality in the servers would be used to ensure the integrity of the messages between server replicas, and it would reduce the number of rounds of message exchanges before agreement is reached.

### 6. Advantages and Technical Properties of the Proposal

6.1 Basic Properties

Bishop [55] identifies confidentiality, integrity and availability as the basic components in which computer security resides. Confidentiality is defined as “the concealment of information and resources”, integrity as “the trustworthiness of data or resources” and availability as “the ability to use the information or resource”. Additionally, Verissimo and Rodrigues [89], define one other basic property, named authenticity, which “is concerned with guaranteeing the origin of a service request, a piece of data or a message, or the identity of a service provider or the creator of a piece of information”.

In this present approach, these properties are ensured at several levels.

6.1.1 Confidentiality

Confidentiality of the data in the computing device is ensured by using a TPM to provide whole-disk encryption, to enforce the secrecy of KDisk, to ask the user for startup tokens and to validate a pre-boot process. Additional confidentiality is enforced by having the operating system require the users to use a login and a password, before they can have access to the data, to prevent any user from accessing the data. Since resetting the TPM erases all the keys inside, data is protected as long as the legitimate user does not keep KDisk together with the computer.

Additionally, the confidentiality of the communications between the computing device and the server are ensured by GSM encryption, but since it has already been attacked, it is reinforced by using cryptographic keys defined while the computer was in control of its legitimate owner. Confidentiality of the communications between the web client and the servers, for reporting a misplaced computer, is ensured by the usage of HTTPS.

Confidentiality of the data stored in the tracking servers is ensured by the fragmentation, randomization and scattering technique, and also by requiring that the user enters a username and password before being able to access the data. This ensures that data from one user is not available to others.

6.1.2 Integrity

The pre-boot validation process ensures that the loading of the operating system fails if the integrity checks over the system fail. These integrity checks comprise the firmware of the most relevant components in the computer and of the GPS/GSM module, some data from the TPM, the BIOS and the MBR, so if one of these is changed without authorization, the computer will not work.

Integrity of the data in transit between the misplaced computer and tracking servers is ensured by digital signatures over the payload, which must be verified before using the payload. Only the TPM generates signatures, and the server is able to verify them using information that was provided by the TPM and stored by the legitimate user.

Integrity at the server side is ensured by the usage of a Byzantine fault-tolerant architecture, in the cases where server replication is required.

6.1.3 Authenticity

The usage of AuthData, ensures that only authenticated and authorised components can interact with the TPM. The communication between the computer and the servers, uses a shared-secret that could only be known by the legitimate user of the computer and is given to the server by the legitimate owner so that it can locate the equipment.

The same digital signatures that ensure integrity also ensure that the request for starting the location information must have come from the legitimate user, assuming he follows the recommendations to store FileR somewhere safe, because only the TPM could have generated that file. For the location information arriving at the server, the digital signature ensures that it was produced by the TPM, since the verification of the signature would not work if any device other than the TPM had used any other key to sign the message.

6.1.4 Availability

A user is able to use the computer as long as it is not reported stolen. When it is reported stolen and recovered by the legitimate user, he can enter the TPM owner password and clear the TPM flag that prevents the computer from being used when it was reported as misplaced.

On the server side, the multiple replica architecture, where applicable, ensures that the servers can still provide valid service even if f of them are failed or compromised.

6.2 Additional Properties

6.2.1 Privacy

The cell network does not retrieve and store location information unless one explicitly authorizes it do so. In this present approach, the legitimate user has to report the equipment misplaced before the GPS/GSM module starts sending location information. In order to do so, the user has to provide information that only the legitimate owner should know. When the computer is recovered, the GPS/GSM modules sends one last message to the server, ordering it to stop collecting location information, and also exists the beacon mode, i.e., stops sending location data.

As a side effect of the confidentiality property, any private files that exist on the computer are kept private. Not only does this approach ensure confidentiality and privacy, it also provides identity preservation, since only the legitimate owner will be able to access the data.

6.2.2 Usability

Even though several passwords and keys are being used, the solution maintains a high level of usability. Most complex operations, such as password definition, are done only once when initially setting up the computer, and some of them are stored in external media so that the user does not have to memories them. The startup password, if one exists, and the operating system password, which the user already had to remember, are the only items to memories. The storage media with the sensitive information can be stored in a secure place and the user only needs to remember where he put them, when something has gone wrong or the user needs to perform maintenance, repair or tracking tasks on the equipment.

The USB token used at startup works like a car key: while it is possible to start a car without its key, and the same happens with a computer using this approach, it should be fairly harder to do so without the matching possession token, i.e., the car key or the USB device. However, the overall gain in security of the system makes up for the reduction in usability.

6.2.3 Mitigation of Denial of Service Attacks

Some denial of service attacks are still possible, but they require more intelligent attackers, which are not the main target of this present approach. If the techniques described in Section 3.8 are not used, an attacker can still delete all the data inside the computer, by attaching the drive to another computer and formatting the drive, but that is generally not the intent of someone who steals a computer.

An attacker can try to jam the GPS or GSM signals, but this requires advanced hacking skills and power, which is usually not the case for someone that steals a computer. In addition, GPS and GSM signals are used for several applications, such as commercial airplanes or other users, and the disruption in the signal would be easily detectable, thus revealing the position of the attacker.

Another kind of denial of service attack, aimed at the mobile device or at the GSM network, is also avoided by requiring that the mobile device or the tracking network only perform heavy computational operations, such as decrypting something, after a signature has been verified, which is a much lighter operation.

### 7. CONCLUSION

Computers are a very important part of most people's life. They store documents, photographs, videos and music, emails, and also private and confidential information. All these files may be hard to replace, if ever possible, or they may be misused by malicious third parties if the computer is lost or stolen. Even though these files are very important, most people do not use any special measures to protect them and do not regularly backup, which means that data will not be easily recoverable if the computer is misplaced. Therefore, it is desired that any solution for this problem ensures that files inside a computer are stored in a secure manner, with only the legitimate user or users being able to access them, and that it is possible to get them back if the computer is misplaced.

For the first part, cryptography can be used, but it usually is hard to setup so most users end up not using it. Backup solutions exist and they allow users to recover data in case of an accident, but the truth is that they are seldom used. The solution I propose intends to achieve confidentiality and recoverability of the equipment and data, in a more user-friendly way. A TPM is used, together with whole-disk encryption, startup tokens and passwords to ensure data confidentiality, and a GPS/GSM module is used to locate and track the computer, once the legitimate owner declares that it has been lost or stolen. Once the computer is reported misplaced and the equipment itself is informed of that, it can no longer be used and has to be taken to a service repair centre. This ensures data confidentiality and recoverability of the equipment when it is required, even if it requires some time.

Authentication, confidentiality, authenticity and integrity of the data flows between the computer and the tracking server are ensured by the usage of shared-key cryptography and digital signatures between the computer and the server, with the digital signatures also being used to mitigate some kinds of denial of service attacks against the server and the computing device. They ensure that the device and the server will only perform a decryption operation once the signature has been verified. The proposed method even addresses some kinds of replay attacks, by ensuring that these signatures are not the same if the computer is stolen or lost more than once.

Privacy of the user is ensured from the start, as the computer will only send location information after the user reports the computer as stolen. This process will also be stopped once the computer is returned to its legitimate owner and the beacon signal of the GPS/GSM is disabled. This GPS/GSM module and the TPM are connected to the computer's main power source, and also to an alternative one, thus ensuring that traceability information can be sent for a longer period, even if the main power source can no longer provide energy for the computer.

Overall, this approach is feasible with minor changes to existing technology and expectedly at a very low cost, in particular when this value is compared against the value of the data inside the computer. While this solution will not reduce the number of stolen computers, it is expected that it is able to increase the number of equipment returned to its rightful owner, and at the same time decrease the effects of data misuse by a malicious user that manages to obtain somebody else's computer. As long as the legitimate user is compliant with the requirements to keep the media containing the disk encryption key, TPM owner password and several other sensitive data, away from the computer, then the confidentiality of the data in a device protected by this solution can be ensured. The recoverability of the equipment is only ensured as long as the computer is not completely destroyed, which should not be the case, at least in the vast majority of times, when it is stolen.

Since the solution is based on the operations provided by the TPM, it is very important that it cannot be reset by everyone. Therefore, in an embodiment, the hard reset procedure is enhanced and, in addition to the hardware operations, it now also requires the user to enter a password that is only known by the computer manufacturer, which should deter most attacks against the TPM. When the legitimate user recovers the computer, the TPM owner password has to be provided in order to make the computer work again. If this key cannot be provided by the legitimate user, he can provide proof of ownership to the computer manufacturer and the TPM can then be reset.

In this present approach, USB devices and startup passwords are used to enforce the level of confidentiality of the whole system. While this is not a complicated approach, it can optionally be improved from a usability point of view. Some computers today already ship with biometric devices, capable of authenticating the owner by reading the fingerprint of the person using the computer. The TPM can be combined with biometric devices, so that one can reduce the need for startup tokens and passwords.

Denial of service attacks on the data are very complicated to prevent, as they are accomplished by deleting the data in the disk, so it would be useful if technology is used to prevent them. This includes a TPM in the disk so that it would not start, even if attached to another computer. However, this increases the overall cost of the solution.

The invention is of course not in any way restricted to the embodiments described and a person with ordinary skill in the art will foresee many possibilities to modifications thereof without departing from the basic idea of the invention as defined in the appended claims.

Obviously, in the present document, any computer suitable data storage is foreseen, so that the term hard disk or similar should be read in this general understanding.

Also, SHA-1 is mentioned as an embodiment but any cryptographic hash function, such as MD5 or SHA-1, may be used in the calculation of an HMAC, so that the term SHA-1 similar should be read in this general understanding.

Also, MBR is mentioned as an embodiment, but any unencrypted startup OS data and/or program, whether in said data storage, whether in firmware, should also be understood by this, so that the term MBR should be read in this general understanding.

Also, the serial numbers of various parts are mentioned as embodiments, but any unique id, whether numeric or not, can be used, such that this term should be read in this general understanding.

Also the terms firmware, BIOS, or firmware and BIOS are mentioned as embodiments, but any suitably non-volatile data memory, or other, suitable to startup a computer after power-on, such that this term should be read in this general understanding.

Also, the geolocation and mobile data module for which GPS/GSM are mentioned as embodiments but any other suitable equivalent technology can be used, namely other geolocation systems such as wireless triangulation systems instead of GPS, or namely other mobile data systems such as CDMA, UMTS, 4G, LTE, WiMax, or equivalent.

### REFERENCES

[1] Ponemon Institute LLC. Fear about id theft. http://www.ponemon.org/index.html, November 2006. 1
[2] Computer Security Institute. The 12th annual computer crime and security survey. Technical report, Computer Security Institute, 2007. 1
[3] Larry Ponemon. Airport insecurity: The case of lost & missing laptops. Technical report, Ponemon Institute LLC, 29 Jul. 2008. 1
[4] Michael Horowitz. Why don't you back up your computer? http://news.cnet.com/, 26 May 2008. 1, 4
[5] HunterPro. Cellpager. http://www.hunterpro.com/Alarm/Cellpager.html, Retrieved on 4 Aug. 2008. 1
[6] Bofan Technology Co. Gps tracking gsm car alarm. http://www.bofan.cc/, Retrieved on 4 Aug. 2008. 1
[7] Vodafone Portugal, i-mob Ibéria, and Blue Security. Wireless safecar. http://www.wirelesssafecar.com/, Retrieved on 9 Aug. 2008. 1
[8] Trusted computing group. https://www.trustedcomputinggroup.org/, 2008. 2.1, 2.4.2
[9] Trusted Computing Group. Tcg tpm specification version 1.2 revision 103-design principles. Technical report, TCG, 9 Jul. 2007. 2.1, 2.1, 3.1, 3.8, 4.3
[10] Luis F. G. Sarmenta, Marten van Dijk, Charles W. O'Donnell, Jonathan Rhodes, and Srinivas Devadas. Virtual monotonic counters and count-limited objects using a tpm without a trusted os. In STC '06: Proceedings of the first ACM workshop on Scalable trusted computing, pages 27-42, New York, N.Y., USA, 3 Nov. 2006. ACM. 2.1, 4.10
[11] M. van Dijk, L. Sarmenta, C. O'Donnell, J. Rhodes, and S. Devadas. Proof of freshness: How to efficiently use on online single secure clock to secure shared untrusted memory. Technical report, MIT Computer Science and Artificial Intelligence Laboratory (CSAIL), September 2006. 2.1
[12] Paul C. van Oorschot. Revisiting software protection. In Lecture Notes in Computer Science, volume 2851/2003, pages 1-13. Springer Berlin/Heidelberg, 15 Jul. 2003. 2.1
[13] William A. Arbaugh, David J. Farbert, and Jonathan M. Smith. A secure and reliable bootstrap architecture. In IEEE Symposium on Security and Privacy, pages 65-71. IEEE COMPUTER SOCIETY, 4-7 May 1997. 2.1, 3.4.2
[14] Reiner Sailer, Leendert Van Doorn, and James P. Ward. The role of tpm in enterprise security. Technical report, IBM Research Division, 6 Oct. 2004. 2.1
[15] Giuliana Santos Veronese, Miguel Correia, Alysson Neves Bessani, Lau Cheuk Lung, and Paulo Verissimo. Minimal byzantine fault tolerance. Technical report, Faculty of Sciences of the University of Lisbon, http://homepages.di.fc.ul.pt/mpc/minbft.pdf, 2008. 2.1, 5.2.2
[16] GSM Association. About the gsm association. http://www.gsmworld.com/about/index.shtml, Retrieved on 30 Jun. 2008. 2.2
[17] HowStuffWorks.com. What does gsm mean in a cell phone? http://electronics.howstuffworks.com/question537.htm, 19 Dec. 2000. 2.2
[18] HowStuffWorks.com. How cell phones work. http://electronics.howstuffworks.com/cell-phone.htm, 14 Nov. 2000. 2.2
[19] Network System Architects Inc. Gsm security. http://www.gsm-security.net/, Retrieved on 28 Jul. 2008. 2.2
[20] 3GPP Organizational Partners. 3rd generation partnership project—technical specification group services and system aspects—3g security—general report on the design, specification and evaluation of 3gpp standard confidentiality and integrity algorithms. Technical Report 3G TR 33.908 version 3.0.0, 3GPP, 17 Mar. 2000. 2.2, 2.2
[21] Alex Biryukov, Adi Shamir, and David Wagner. Real time cryptanalysis of a5/1 on a pc. Fast Software Encryption Workshop 2000, 10-12 Apr. 2000. 2.2
[22] Ian Goldberg, David Wagner, and Lucky Green. The real-time cryptanalysis of a5/2. Rump Session of Crypto'99, 15-19 Aug. 1999. 2.2
[23] Andrey Bogdanov, Thomas Eisenbarth, and Andy Rupp. A hardware-assisted realtime attack on a5/2 without precomputations. In Cryptographic Hardware and Embedded Systems—CHES 2007, volume 4727/2007, pages 394-412. Springer Berlin/Heidelberg, 10-13 Sep. 2007. 2.2
[24] Elad Barkan, Eli Biham, and Nathan Keller. Instant ciphertext-only cryptanalysis of gsm encrypted communications. In Advances in Cryptology—CRYPTO 2003, pages 600-616. Springer, 17-21 Aug. 2003. 2.2
[25] European Telecommunications Standards Institute. Digital cellular telecommunications system (phase 2+) (gsm); background for radio frequency (rf) requirements (gsm 05.50 version 8.2.0 release 1999). Technical Report ETSI TR 101 115 V8.2.0, ETSI, April 2000. 2.2
[26] TelecomSpace. General packet radio service. http://www.telecomspace.com/datatech-gprs.html, June 2008. 2.2
[27] European Telecommunications Standards Institute. Digital cellular telecommunications system (phase 2+) (gsm)-security related network functions. Technical Report GSM 03.20 version 7.2.0, ETSI, 11 Nov. 1999. 2.2
[28] Christos Xenakis and Lazaros Merakos. Vulnerabilities and possible attacks against the gprs backbone network. In Critical Information Infrastructures Security, volume 4347/2006, pages 262-272. Springer Berlin/Heidelberg, 30 Aug.-2 Sep. 2006. 2.2
[29] UMTS World. Edge-enhanced data rates for gsm evolution. http://www.umtsworld.com/technology/edge.htm, 2001. 2.2
[30] UMTS World. Wcdma (umts). http://www.umtsworld.com/technology/wcdma.htm, 2001. 2.2
[31] 3GPP Organizational Partners. 3rd generation partnership project—technical specification group radio access networks—umts 1700/2100 mhz work item technical report (release 7). Technical Report 3GPP TR 25.806 V7.0.0, 3GPP, 5 Oct. 2006. 2.2
[32] GSA The Global mobile Suppliers Association. Gsm/3g market update. http://www.gsacom.com, 2 Jun. 2008. 2.2
[33] 3GPP Organizational Partners. 3rd generation partnership project—technical specification group sa wg3—a guide to 3rd generation security. Technical Report 3G TR 33.900 version 1.2.0, 3GPP, 19-21 Jan. 2000. 2.2
[34] Ulrike Meyer and Susanne Wetzel. A man-in-the-middle attack on umts. In WiSe '04: 3rd ACM workshop on Wireless security, pages 90-97, 01 Oct. 2004. 2.2
[35] GSM Association. Hspa devices update. http://hspa.gsmworld.com, October 2007. 2.2
[36] Federal Aviation Administration. Faa gnss—frequently asked questions—gps. http://www.faa.gov/, 5 Feb. 2008. 2.3.1
[37] Samuel J. Wormley. Gps errors: Estimating your receiver's accuracy. http://edu-observatory.org, 30 Mar. 2007. 2.3.1
[38] Russia Information Agency. Glonass system to consist of 30 satellites. http://en.rian.ru/russia/20080321/101957980.html, 21 Mar. 2008. 2.3.1
[39] Russian Space Agency. Glonass constellation status. http://www.glonass-ianc.rsa.ru/, 24 Jun. 2008. 2.3.1
[40] Andrew E. Kramer. Russia challenges the u.s. monopoly on satellite navigation. The New York Times, 4 Apr. 2007. 2.3.1
[41] Keith M. Miller. A review of glonass. The Hydrographic Journal, (98), October 2000. 2.3.1
[42] Directorate-General Energy and Transport. Galileo—the european programme for global navigation services—2nd edition. Technical report, European Commission, January 2005. 2.3.1
[43] BBC. Bbc news: ‘unanimous backing’ for galileo. http://news.bbc.co.uk/2/hi/science/nature/7120041.stm, 30 Nov. 2007. 2.3.1
[44] Chinese Defence Today. Compass navigation satellite system (beidou 2). http://www.sinodefence.com/strategic/spacecraft/beidou2.asp, 3 Feb. 2007. 2.3.1
[45] K. Raghu. India to build a constellation of 7 navigation satellites by 2012. Livemint.com—The Wall Street Journal, 5 Sep. 2007. 2.3.1
[46] Apple Inc. Apple iphone. http://www.apple.com/iphone/, Retrieved on 25 Jul. 2008. 2.3.1, 2.3.2
[47] GSM Association. Location based services 3.1.0. Technical Report PRD SE.23, GSM Association, January 2003. 2.3.2
[48] Vodafone. Google maps with location based services on vodafone mobile phones. http://www.vodafone.com, 26 Mar. 2008. 2.3.2
[49] Nokia Siemens Networks. Telkomsel to deploy state-of-the art location based services to its customers across Indonesia. Press release on http://www.nokiasiemensnetworks.com, 12 Mar. 2008. 2.3.2
[50] Steve Litchfield. Assisted gps and the future of smartphones. http://www.allaboutsymbian.com, 27 Jun. 2007. 2.3.2
[51] Nokia. Nokia europe-nokia n96-products. http://europe.nokia.com/n96, Retrieved on 25 Jul. 2008. 2.3.2
[52] Iler Group Inc. Gps fleetsolutions. http://www.gpsfleetsolutions.com/, Retrieved on 16 Jul. 2008. 2.3.2
[53] Gemini Technologies. Gemtek personal tracking device: Real-time gps tracking device from gemini technologies. http://www.geminitracking.com/, Retrieved on 16 Jul. 2008. 2.3.2
[54] Laipac Tech. S-911 personal locator. http://www.laipac.com, Retrieved on 16 Jul. 2008. 2.3.2
[55] Matt Bishop. Computer Security: Art and Science. Addison-Wesley, Boston, Mass., USA, 12 Dec. 2002. ISBN 0201440997. 2.4.1, 2.4.2, 3.2, 3.4, 6.1
[56] Microsoft Corporation. Windows. http://www.microsoft.com/windows/default.aspx, Retrieved on 9 Aug. 2008. 2.4.1
[57] Bart Lagerweij. Bart's preinstalled environment (bartpe) bootable live windows cd/dvd. http://www.nu2.nu/pebuilder/, 17 Feb. 2006. 2.4.1
[58] S. Garfinkel, G. Spafford, and A. Schwartz. Practical Unix and Internet Security. O'Reilly, Sebastopol, Calif., USA, 3rd edition, 21 Feb. 2003. ISBN 0596003234. 2.4.1
[59] Apple Inc. How to use firewire target disk mode. http://support.apple.com/kb/HT1661, 20 May 2008. 2.4.1
[60] IEEE Computer Society. leee p1619 security in storage working group (siswg). http://siswg.net/, 12 Jun. 2007. 2.4.2
[61] Apple Inc. Mac os x 10.4 help: Encrypting your home folder with filevault. http://docs.info.apple.com/article.html?path=Mac/10.4/en/mh1906.html, Retrieved on 3 Jul. 2008. 2.4.2, 3
[62] Microsoft Corporation. Windows bitlocker drive encryption. http://technet.microsoft.com/en-us/windows/aa905065.aspx, Retrieved on 3 Jul. 2008. 2.4.2, 3, 3.4.2
[63] J. Alex Halderman, Seth D. Schoen, Nadia Heninger, William Clarkson, William Paul, Joseph A. Calandrino, Ariel J. Feldman, Jacob Appelbaum, and Edward W. Felten. Lest we remember: Cold boot attacks on encryption keys. In 17th USENIX Security Symposium, 28 Jul.-1 Aug. 2008. 2.4.2
[64] Anitec. Anitec—one step ahead. http://www.anitec.ca, Retrieved on 24 Sep. 2008. 2.5
[65] SemiconductorStore.com. Semiconductor store. http://www.semiconductorstore.com, Retrieved on 23 Sep. 2008. 2.5
[66] Round Solutions. Specialists in machine-to-machine (m2m) communications. http://www.roundsolutions.com/, Retrieved on 27 Jul. 2008. 2.5
[67] Round Solutions. Gsm-umts (850/900/1800/1900 mhz) antennas. http://www.roundsolutions.com/gsm-antenna/, Retrieved on 24 Sep. 2008. 2.5, 4.2
[68] PGP. Pgp whole disk encryption. http://www.pgp.com/products/wholediskencryption/index.html, Retrieved on 3 Jul. 2008. 3, 3.7.2
[69] Microsoft Corporation. Windows bitlocker drive encryption step-by-step guide. http://technet.microsoft.com/en-us/library/cc766295.aspx, 30 Apr. 2007. 3.4.2
[70] Microsoft Corporation. Windows bitlocker drive encryption frequently asked questions. http://technet.microsoft.com/en-us/library/cc766200.aspx, 4 Mar. 2007. 3.4.2
[71] CyberScrub LLC. Decommissioning magnetic media—security issues with decommissioning magnetic media. http://www.cyberscrub.com, Retrieved on 27 Jul. 2008. 3.7.4
[72] Apple Inc. Time machine. http://www.apple.com/macosx/features/timemachine.html, 26 Oct. 2007. 4
[73] 2BrightSparks. Syncbackse. http://www.2brightsparks.com/syncback/sbse.html, Retrieved on 6 Oct. 2008. 4
[74] Iternum. Trackmyfiles. http://www.trackmyfiles.com/en/home/, Retrieved on 6 Oct. 2008. 4
[75] Absolute Software. Lojack for laptops. http://www.lojackforlaptops.com/, Retrieved on 7 Jul. 2008. 4.1
[76] WestinTech. Gadgettrak laptop theft recovery software: Privacy-safe theft recovery. http://www.gadgettrak.com/products/laptop/, Retrieved on 7 Jul. 2008. 4.1
[77] Orbicule Inc. Undercover: recover your stolen mac, anywhere in the universe. http://www.orbicule.com/undercover/, 30 Oct. 2007. 4.1
[78] Dell. Dell prosupport. http://dell.com/ProSupport, Retrieved on 2 Aug. 2008. 4.1
[79] Thomas Ristenpart, Gabriel Maganis, Arvind Krishnamurthy, and Tadayoshi Kohno. Privacy-preserving location tracking of lost or stolen devices: Cryptographic techniques and replacing trusted third parties with dhts. In 17th Usenix Security Symposium, 28 Jul.-1 Aug. 2008. 4.1
[80] Gabriel Maganis, Thomas Ristenpart, Tadayoshi Kohno, and Arvind Krishnamurthy. Adeona: A free, open source system for helping track and recover lost and stolen laptops. http://adeona.cs.washington.edu/, Retrieved on 19 Jul. 2008. 4.1
[81] Pro-Talk Ltd. Embedded oem module combines gsm with gps. http://www.electronicstalk.com/news/azz/azz103.html, Retrieved on 25 Jul. 2008. 4.2
[82] Telit Wireless Solutions. Ge863-gps. http://www.telit.com/en/products/gsm-gprs.php, Retrieved on 25 Jul. 2008. 4.2
[83] Laipac Tech. Active antenna for gps and cellphone 2 in 1. http://www.laipac.com, Retrieved on 27 Jul. 2008. 4.2
[84] IEEE Computer Society. leee standard for information technology—telecommunications and information exchange between systems—local and metropolitan area networks—specific requirements: Part 11: Wireless Ian medium access control (mac) and physical layer (phy) specifications. Technical report, IEEE, 12 Jun. 2007. 4.2
[85] TechTarget. Faraday cage. http://searchsecurity.techtarget.com, 21 Dec. 2003. 4.2
[86] Vitalwerks Internet Solutions LLC. No-ip-dynamic dns, static dns for your dynamic ip. http://www.no-ip.com/, Retrieved on 6 Oct. 2008. 5.2.1
[87] NetDorm Inc. Free dynamic dns, static dns for dynamic ip. http://www.dnsexit.com/, Retrieved on 6 Oct. 2008. 5.2.1
[88] Miguel Castro and Barbara Liskov. Practical byzantine fault tolerance. In 3rd Symposium on Operating Systems Design and Implementation, 22-25 Feb. 1999. 5.2.2
[89] Paulo Verissimo and Luis Rodrigues. Distributed Systems for System Architects. Kluwer Academic Publishers, Norwell, Mass., USA, January 2001. ISBN 0792372662.6.1

What is claimed is:

1. Method for securing, including pre-boot validation, of a computing device with data storage, power-on firmware—BIOS, and a Trusted Platform Module—TPM, said method comprising the steps of:
using a TPM to provide full data storage encryption, with the proviso that the OS startup part—MBR of the data storage may or may not be encrypted;
storing appropriate keys for full data storage encryption in the TPM and requiring that resetting the TPM erases all the keys inside the TPM;
using the TPM and the previously stored keys for verifying the pre-boot integrity of the computing device firmware, in particular the BIOS, and the computing device MBR, and unique IDs of the computing device components used in this method, in particular the TPM, the BIOS and if present a geolocation and mobile data—GPS/GSM module.

2. Method according to claim 1 for securing a computing device with data storage, power-on firmware—BIOS, and a Trusted Platform Module—TPM, said method comprising the steps of:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
the TPM deterministically deriving a key—KOwner, from the Owner password of the TPM;
the TPM calculating a hash-based message authentication code HMAC—h1 using KOwner over the BIOS, MBR, unique ID of the TPM and unique ID of the BIOS;
the TPM calculating a hash-based message authentication code HMAC—h2 using KOwner over the BIOS, unique ID of the TPM and unique ID of the BIOS;
the TPM signing h1 and h2 with the private part of the endorsement key of the TPM—respectively s1 and s2; and storing s1 in the TPM;
supplying the user of the computing device with h1 and s2, for external storage;
the TPM deterministically deriving a key—KMaster, from h1;
the TPM encrypting KDisk with KMaster, storing the encrypted KDisk in the TPM, disposing of KMaster.

3. Method according to claim 1 for pre-boot validation for securing a computing device with data storage, power-on firmware—BIOS, and a Trusted Platform Module—TPM, said method comprising the steps of:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM calculating a hash-based message authentication code HMAC—h1′ using KOwner over the BIOS, MBR, unique ID of the TPM and unique ID of the BIOS;
the TPM signing h1′ with the private part of the endorsement key of the TPM—s1′;
the TPM retrieving a previously and similarly calculated HMAC and previously signed with the private part of the endorsement key of the TPM—s1;
the TPM comparing s1′ and s1 and if matched continuing the method, otherwise signaling a component change for suitable action by the user;
the TPM deterministically deriving a key—KMaster, from h1;
the TPM decrypting the previously stored description key for the data storage—KDisk with KMaster.
the TPM uses KDisk to decrypt the data storage, disposes of KMaster and allows the OS to start.

4. Method according to claim 3, further comprising if signalled a component change the steps of:
the TPM calculating a hash-based message authentication code HMAC—h2′ using KOwner over the BIOS, unique ID of the TPM and unique ID of the BIOS;
the TPM signing h2′ with the private part of the endorsement key of the TPM—s2′;
the TPM asking the user to provide the previously calculated and externally stored hash-based message authentication code HMAC—h1 using KOwner over the BIOS, MBR, unique ID of the TPM and unique ID of the BIOS;
the TPM asking the user to provide the previously calculated, signed and externally stored hash-based message authentication code HMAC—s2 using KOwner over the BIOS, unique ID of the TPM and unique ID of the BIOS;
the TPM comparing s2′ and s2 and if matched continuing the method, otherwise signaling an unauthorized action and stopping the boot process;
the TPM signing h1 with the private part of the endorsement key of the TPM—s1″;
the TPM comparing s1″ and s1 and if matched continuing the method, otherwise signaling an unauthorized action and stopping the boot process;
resuming the pre-boot validation.

5. Method according to claim 1 for securing a computing device with data storage, power-on firmware—BIOS, and a Trusted Platform Module—TPM, said method comprising the steps of:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
user optionally providing a password, passphrase or pin from the user, herein referred as a password;
user optionally providing an token device;
the TPM storing indication if the user has provided a password, or if the user has provided a token device, or if has provided both—in TPMflags;
the TPM deterministically deriving a key—KOwner, from the Owner password of the TPM;
the TPM calculating a hash-based message authentication code HMAC—h1 over the BIOS, TPMflags, MBR, unique ID of the TPM and unique ID of the BIOS using KOwner, with the proviso of KOwner being previous XOR-ed with the user input password if provided;
the TPM calculating a hash-based message authentication code HMAC—h2 over the BIOS, TPMflags, unique ID of the TPM and unique ID of the BIOS using KOwner, with the proviso of KOwner being previously XOR-ed with the user input password if provided;
the TPM signing h1 and h2 with the private part of the endorsement key of the TPM—respectively s1 and s2; and storing s1 in the TPM;
supplying the user of the computing device with h1 and s2, for external storage;
the TPM deterministically deriving a key—KMaster, from h1;
the TPM encrypting KDisk with KMaster;
if the user has provided a token device, storing a first part of the encrypted KDisk in the TPM and storing a second part of the encrypted KDisk in the token device;
if the user has not provided a token device, storing the encrypted KDisk in the TPM;
the TPM disposing of KMaster.

6. Method according to claim 1 for pre-boot validation for securing a computing device with data storage, power-on firmware—BIOS, and a Trusted Platform Module—TPM, said method comprising the steps of:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM retrieving a previously stored indication if the user has provided a password, or if the user has provided a token device, or if has provided both—TPMflags;
if the necessary token device or password are not provided, stopping the boot process, otherwise continuing the method;
the TPM calculating a hash-based message authentication code HMAC—h1′ using KOwner over the BIOS, TPMflags, MBR, unique ID of the TPM and unique ID of the BIOS, with the proviso of KOwner being previously XOR-ed with the user input password if provided;
the TPM signing h1′ with the private part of the endorsement key of the TPM—s1′;
the TPM retrieving a previously and similarly calculated HMAC and previously signed with the private part of the endorsement key of the TPM—s1;
the TPM comparing s1′ and s1 and if matched continuing the method, otherwise signaling a component change for suitable action by the user;
the TPM deterministically deriving a key—KMaster, from h1;
the TPM decrypting the previously stored description key for the data storage—KDisk with KMaster.
the TPM uses KDisk to decrypt the data storage, disposes of KMaster, and allows the OS to start.

7. Method according to claim 6, further comprising if signalled a component change the steps of:
the TPM calculating a hash-based message authentication code HMAC—h2′ using KOwner over the BIOS, TPMflags, unique ID of the TPM and unique ID of the BIOS, with the proviso of KOwner being previously XOR-ed with the user input password if provided;
the TPM signing h2′ with the private part of the endorsement key of the TPM—s2′;
the TPM asking the user to provide the previously calculated and externally stored hash-based message authentication code HMAC—h1 using KOwner over the BIOS, MBR, unique ID of the TPM and unique ID of the BIOS;
the TPM asking the user to provide the previously calculated, signed and externally stored hash-based message authentication code HMAC—s2 using KOwner over the BIOS, unique ID of the TPM and unique ID of the BIOS;
the TPM comparing s2′ and s2 and if matched continuing the method, otherwise signaling an unauthorized action and stopping the boot process;
the TPM signing h1 with the private part of the endorsement key of the TPM—s1″;
the TPM comparing s1″ and s1 and if matched continuing the method, otherwise signaling an unauthorized action and stopping the boot process;
resuming the pre-boot validation.

8. Method according to claim 1 for securing a computing device with data storage, power-on firmware—BIOS, geolocation and mobile data—GPS/GSM module, and a Trusted Platform Module—TPM, said method comprising the steps of:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
user optionally providing a password, passphrase or pin from the user, herein referred as a password;
user optionally providing an token device;
the TPM storing indication if the user has provided a password, or if the user has provided a token device, or if has provided both, storing indication if the computing device was reported misplaced or not, with the default value, which corresponds to indicating the computing device has not been misplaced—in TPMflags.
the TPM deterministically deriving a key—KOwner, from the Owner password of the TPM;
the TPM calculating a hash-based message authentication code HMAC—h10 over the BIOS, GPS/GSM module firmware, TPMflags, MBR, unique ID of the TPM, unique ID of the GPS/GSM module, and unique ID of the BIOS using KOwner, with the proviso of KOwner being previous XOR-ed with the user input password if provided;
the TPM calculating a hash-based message authentication code HMAC—h20 over the BIOS, GPS/GSM module firmware, TPMflags, unique ID of the TPM, unique ID of the GPS/GSM module, and unique ID of the BIOS using KOwner, with the proviso of KOwner being previously XOR-ed with the user input password if provided;
the TPM calculating two other hash-based message authentication codes HMAC—h11 and h21, as in h10 and h20, but as if the computing device had been misplaced;
the TPM signing h10, h11, h20 and h21 with the private part of the endorsement key of the TPM—respectively s10, s11, s20 and s21; and storing s10 and s11 in the TPM;
supplying the user of the computing device with h10, s20 and s21, for external storage;
the TPM deterministically deriving and storing a key—Kgsm, from KOwner;
the TPM deterministically deriving a key pair—Ksig,gsm, from KOwner;
the TPM encrypting h10 with Kgsm, signing the encrypted value with the private part of Ksig,gsm and concatenating the encrypted value with the signed value—SMSDATA;
supplying the user of the computing device with a file—FileR comprising the SMSDATA value and the public part of Ksig,gsm, for external storage;
the TPM deterministically deriving a key—KMaster, from h10;
the TPM encrypting KDisk with KMaster;
if the user has provided a token device, storing a first part of the encrypted KDisk in the TPM and storing a second part of the encrypted KDisk in the token device;
if the user has not provided a token device, storing the encrypted KDisk in the TPM;
the TPM disposing of KMaster.

9. Method according to claim 8, further comprising, if the computing device is signalled misplaced, the steps of:
a central server retrieving the file FileR and the owner password from the user, and thus obtaining SMSDATA, the public part of Ksig.gsm and Kgsm;
the central server sending a message containing h10 encrypted with Kgsm and signed with the private part of Ksig.gsm;
the TPM receiving the message through the GPS/GSM module;
the TPM verifying the signature, continuing if verified; ignoring the message and stopping if not;
the TPM decrypting h10 with Kgsm, signing h10 with the private part of its endorsement key—obtaining s10;
the TPM verifying if s10 matches the one stored inside the TPM, continuing if verified; ignoring the message and stopping if not;
the TPM changes its internal information such that the equipment has been misplaced and starts sending frequent messages with the device location.

10. Method according to claim 9, wherein the frequent messages containing the misplaced computing device location contain the device location encrypted with Kgsm, concatenated with the phone number, if existing, of the GPS/GSM module, signed with the private part of Ksig,gsm, and further comprising the step of:
the central server receiving the message and verifying the signature, ignoring the message if not verified; otherwise recording or notifying, or recording and notifying of the received device location.

11. Method according to claim 10, for marking the computed device as recovered and stopping the central server from recording or notifying the computing device location, further comprising the steps of:
the TPM encrypting stop information using Kgsm, concatenating it with the phone number, if existing, of the GPS/GSM module, and signing with the private part of Ksig,gsm;
the central server receiving the message and verifying the signature, ignoring the message if not verified; otherwise stopping the recordal or notification of the device location.

12. Method according to claim 1 for pre-boot validation for securing a computing device with data storage, power-on firmware—BIOS, and a Trusted Platform Module—TPM, said method comprising the steps of:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM retrieving a previously stored indication if the user has provided a password, or if the user has provided a token device, or if has provided both—TPMflags;
if the necessary token device or password are not provided, stopping the boot process, otherwise continuing the method;
the TPM calculating a hash-based message authentication code HMAC—h10′ using KOwner over the BIOS, GPS/GSM module firmware, TPMflags, MBR, unique ID of the TPM, unique ID of the GPS/GSM module, and unique ID of the BIOS, with the proviso of KOwner being previously XOR-ed with the user input password if provided;
the TPM calculating a hash-based message authentication code HMAC—h20′ using KOwner over the BIOS, GPS/GSM module firmware, TPMflags, unique ID of the TPM, unique ID of the GPS/GSM module, and unique ID of the BIOS, with the proviso of KOwner being previously XOR-ed with the user input password if provided;
the TPM calculating two other hash-based message authentication codes HMAC—h11′ and h21′, as in h10′ and h20′, but as if the computing device had been misplaced;
the TPM signing h10′, h11′, h20′ and h21′ with the private part of the endorsement key of the TPM—respectively s10′, s11′, s20′ and s21′;
the TPM retrieving the previously and similarly calculated HMAC codes and previously signed with the private part of the endorsement key of the TPM—s10 and s11;
the TPM comparing s10′ with s10,
i. if matched continuing the method,
ii. then otherwise, the TPM comparing s11′ with s11,
1. if matched signaling the computing device has been misplaced and stopping the boot process;
2. otherwise signaling a component change for suitable action by the user;
the TPM deterministically deriving a key—KMaster, from h10;
the TPM decrypting the previously stored description key for the data storage—KDisk with KMaster.
the TPM uses KDisk to decrypt the data storage, disposes of KMaster, and allows the OS to start.

13. Method according to claim 12, further comprising if signalled a component change the steps of:
the TPM asking the user to provide the previously calculated and externally stored hash-based message authentication code HMAC—h10, s20, s21 corresponding to h10′, s20′, s21′;
the TPM comparing s20′ and s20 and
i. if matched, continuing the method,
ii. otherwise, the TPM comparing s21′ and s21 and
1. if matched, signaling the computing device has been misplaced and stopping the boot process,
2. otherwise, signaling an unauthorized action and stopping the boot process;
the TPM signing h10 with the private part of the endorsement key of the TPM—s10″;
the TPM comparing s10″ and s10 and if matched continuing the method, otherwise signaling an unauthorized action and stopping the boot process;
resuming the pre-boot validation.

14. A system for securing, including pre-boot validation, of a computing device comprising data storage, power-on firmware—BIOS, and a Trusted Platform Module—TPM, said system comprising data processor means for:
using a TPM to provide full data storage encryption, with the proviso that the OS startup part—MBR of the data storage may or may not be encrypted;
storing appropriate keys for full data storage encryption in the TPM and requiring that resetting the TPM erases all the keys inside the TPM;
using the TPM and the previously stored keys for verifying the pre-boot integrity of the computing device firmware, in particular the BIOS, and the computing device MBR, and unique IDs of the computing device components used in this system, in particular the TPM, the BIOS and if present a geolocation and mobile data—GPS/GSM module.

15. System according to claim 14 for securing a computing device comprising data storage, power-on firmware—BIOS, and a Trusted Platform Module—TPM, said system comprising data processor means for:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
the TPM deterministically deriving a key—KOwner, from the Owner password of the TPM;
the TPM calculating a hash-based message authentication code HMAC—h1 using KOwner over the BIOS, MBR, unique ID of the TPM and unique ID of the BIOS;
the TPM calculating a hash-based message authentication code HMAC—h2 using KOwner over the BIOS, unique ID of the TPM and unique ID of the BIOS;
the TPM signing h1 and h2 with the private part of the endorsement key of the TPM—respectively s1 and s2; and storing s1 in the TPM;
supplying the user of the computing device with h1 and s2, for external storage;
the TPM deterministically deriving a key—KMaster, from h1;
the TPM encrypting KDisk with KMaster, storing the encrypted KDisk in the TPM, disposing of KMaster.

16. System according to claim 14 for pre-boot validation for securing a computing device comprising data storage, power-on firmware—BIOS, and a Trusted Platform Module—TPM, said system comprising data processor means for:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM calculating a hash-based message authentication code HMAC—h1′ using KOwner over the BIOS, MBR, unique ID of the TPM and unique ID of the BIOS;
the TPM signing h1′ with the private part of the endorsement key of the TPM—s1′;
the TPM retrieving a previously and similarly calculated HMAC and previously signed with the private part of the endorsement key of the TPM—s1;
the TPM comparing s1′ and s1 and if matched continuing, otherwise signaling a component change for suitable action by the user;
the TPM deterministically deriving a key—KMaster, from h1;
the TPM decrypting the previously stored description key for the data storage—KDisk with KMaster.
the TPM uses KDisk to decrypt the data storage, disposes of KMaster and allows the OS to start.

17. System according to claim 16, further comprising if signalled a component change, data processor means for:
the TPM calculating a hash-based message authentication code HMAC—h2′ using KOwner over the BIOS, unique ID of the TPM and unique ID of the BIOS;
the TPM signing h2′ with the private part of the endorsement key of the TPM—s2′;
the TPM asking the user to provide the previously calculated and externally stored hash-based message authentication code HMAC—h1 using KOwner over the BIOS, MBR, unique ID of the TPM and unique ID of the BIOS;
the TPM asking the user to provide the previously calculated, signed and externally stored hash-based message authentication code HMAC—s2 using KOwner over the BIOS, unique ID of the TPM and unique ID of the BIOS;
the TPM comparing s2′ and s2 and if matched continuing, otherwise signaling an unauthorized action and stopping the boot process;
the TPM signing h1 with the private part of the endorsement key of the TPM—s1″;
the TPM comparing s1″ and s1 and if matched continuing, otherwise signaling an unauthorized action and stopping the boot process;
resuming the pre-boot validation.

18. System according to claim 14 for securing a computing device comprising data storage, power-on firmware—BIOS, geolocation and mobile data—GPS/GSM module, and a Trusted Platform Module—TPM, said system comprising data processor means for:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
user optionally providing a password, passphrase or pin from the user, herein referred as a password;
user optionally providing an token device;
the TPM storing indication if the user has provided a password, or if the user has provided a token device, or if has provided both, storing indication if the computing device was reported misplaced or not, with the default value, which corresponds to indicating the computing device has not been misplaced—in TPMflags.
the TPM deterministically deriving a key—KOwner, from the Owner password of the TPM;
the TPM calculating a hash-based message authentication code HMAC—h10 over the BIOS, GPS/GSM module firmware, TPMflags, MBR, unique ID of the TPM, unique ID of the GPS/GSM module, and unique ID of the BIOS using KOwner, with the proviso of KOwner being previous XOR-ed with the user input password if provided;
the TPM calculating a hash-based message authentication code HMAC—h20 over the BIOS, GPS/GSM module firmware, TPMflags, unique ID of the TPM, unique ID of the GPS/GSM module, and unique ID of the BIOS using KOwner, with the proviso of KOwner being previously XOR-ed with the user input password if provided;
the TPM calculating two other hash-based message authentication codes HMAC—h11 and h21, as in h10 and h20, but as if the computing device had been misplaced;
the TPM signing h10, h11, h20 and h21 with the private part of the endorsement key of the TPM—respectively s10, s11, s20 and s21; and storing s10 and s11 in the TPM;
supplying the user of the computing device with h10, s20 and s21, for external storage;
the TPM deterministically deriving and storing a key—Kgsm, from KOwner;
the TPM deterministically deriving a key pair—Ksig,gsm, from KOwner;
the TPM encrypting h10 with Kgsm, signing the encrypted value with the private part of Ksig,gsm and concatenating the encrypted value with the signed value—SMSDATA;
supplying the user of the computing device with a file—FileR comprising the SMSDATA value and the public part of Ksig,gsm, for external storage;
the TPM deterministically deriving a key—KMaster, from h10;
the TPM encrypting KDisk with KMaster;
if the user has provided a token device, storing a first part of the encrypted KDisk in the TPM and storing a second part of the encrypted KDisk in the token device;
if the user has not provided a token device, storing the encrypted KDisk in the TPM;
the TPM disposing of KMaster.

19. System according to claim 14 for pre-boot validation for securing a computing device comprising data storage, power-on firmware—BIOS, and a Trusted Platform Module—TPM, said system comprising data processor means for:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM retrieving a previously stored indication if the user has provided a password, or if the user has provided a token device, or if has provided both—TPMflags;
if the necessary token device or password are not provided, stopping the boot process, otherwise continuing;
the TPM calculating a hash-based message authentication code HMAC—h10′ using KOwner over the BIOS, GPS/GSM module firmware, TPMflags, MBR, unique ID of the TPM, unique ID of the GPS/GSM module, and unique ID of the BIOS, with the proviso of KOwner being previously XOR-ed with the user input password if provided;
the TPM calculating a hash-based message authentication code HMAC—h20′ using KOwner over the BIOS, GPS/GSM module firmware, TPMflags, unique ID of the TPM, unique ID of the GPS/GSM module, and unique ID of the BIOS, with the proviso of KOwner being previously XOR-ed with the user input password if provided;
the TPM calculating two other hash-based message authentication codes HMAC—h11′ and h21′, as in h10′ and h20′, but as if the computing device had been misplaced;
the TPM signing h10′, h11′, h20′ and h21′ with the private part of the endorsement key of the TPM—respectively s10′, s11′, s20′ and s21′;
the TPM retrieving the previously and similarly calculated HMAC codes and previously signed with the private part of the endorsement key of the TPM—s10 and s11;
the TPM comparing s10′ with s10,
i. if matched continuing,
ii. then otherwise, the TPM comparing s11′ with s11,
1. if matched signaling the computing device has been misplaced and stopping the boot process;
2. otherwise signaling a component change for suitable action by the user;
the TPM deterministically deriving a key—KMaster, from h10;
the TPM decrypting the previously stored description key for the data storage—KDisk with KMaster.
the TPM uses KDisk to decrypt the data storage, disposes of KMaster, and allows the OS to start.

20. System according to claim 19, further comprising if signalled a component change, data processor means for:
the TPM asking the user to provide the previously calculated and externally stored hash-based message authentication code HMAC—h10, s20, s21 corresponding to h10′, s20′, s21′;
the TPM comparing s20′ and s20 and
i. if matched, continuing,
ii. otherwise, the TPM comparing s21′ and s21 and
1. if matched, signaling the computing device has been misplaced and stopping the boot process,
2. otherwise, signaling an unauthorized action and stopping the boot process;
the TPM signing h10 with the private part of the endorsement key of the TPM—s10″;
the TPM comparing s10″ and s10 and if matched continuing, otherwise signaling an unauthorized action and stopping the boot process;
resuming the pre-boot validation.

21. A computer program product stored on a computer readable medium for securing, including pre-boot validation, of a computing device comprising data storage, power-on firmware—BIOS, and a Trusted Platform Module—TPM, said computer program product comprising program instructions for:
using a TPM to provide full data storage encryption, with the proviso that the OS startup part—MBR of the data storage may or may not be encrypted;
storing appropriate keys for full data storage encryption in the TPM and requiring that resetting the TPM erases all the keys inside the TPM;
using the TPM and the previously stored keys for verifying the pre-boot integrity of the computing device firmware, in particular the BIOS, and the computing device MBR, and unique IDs of the computing device components used, in particular the TPM, the BIOS and if present a geolocation and mobile data—GPS/GSM module.

22. A computer program product stored on a computer readable medium according to claim 21 for securing a computing device comprising data storage, power-on firmware—BIOS, and a Trusted Platform Module—TPM, said computer program product comprising program instructions for:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
the TPM deterministically deriving a key—KOwner, from the Owner password of the TPM;
the TPM calculating a hash-based message authentication code HMAC—h1 using KOwner over the BIOS, MBR, unique ID of the TPM and unique ID of the BIOS;
the TPM calculating a hash-based message authentication code HMAC—h2 using KOwner over the BIOS, unique ID of the TPM and unique ID of the BIOS;
the TPM signing h1 and h2 with the private part of the endorsement key of the TPM—respectively s1 and s2; and storing s1 in the TPM;
supplying the user of the computing device with h1 and s2, for external storage;
the TPM deterministically deriving a key—KMaster, from h1;
the TPM encrypting KDisk with KMaster, storing the encrypted KDisk in the TPM, disposing of KMaster.

23. A computer program product stored on a computer readable medium according to claim 21 for pre-boot validation for securing a computing device comprising data storage, power-on firmware—BIOS, and a Trusted Platform Module—TPM, said computer program product comprising program instructions for:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM calculating a hash-based message authentication code HMAC—h1′ using KOwner over the BIOS, MBR, unique ID of the TPM and unique ID of the BIOS;
the TPM signing h1′ with the private part of the endorsement key of the TPM—s1′;
the TPM retrieving a previously and similarly calculated HMAC and previously signed with the private part of the endorsement key of the TPM—s1;
the TPM comparing s1′ and s1 and if matched continuing, otherwise signaling a component change for suitable action by the user;
the TPM deterministically deriving a key—KMaster, from h1;
the TPM decrypting the previously stored description key for the data storage—KDisk with KMaster.
the TPM uses KDisk to decrypt the data storage, disposes of KMaster and allows the OS to start.

24. A computer program product stored on a computer readable medium according to claim 23, further comprising program instructions for, if signalled a component change:
the TPM calculating a hash-based message authentication code HMAC—h2′ using KOwner over the BIOS, unique ID of the TPM and unique ID of the BIOS;
the TPM signing h2′ with the private part of the endorsement key of the TPM—s2′;
the TPM asking the user to provide the previously calculated and externally stored hash-based message authentication code HMAC—h1 using KOwner over the BIOS, MBR, unique ID of the TPM and unique ID of the BIOS;
the TPM asking the user to provide the previously calculated, signed and externally stored hash-based message authentication code HMAC—s2 using KOwner over the BIOS, unique ID of the TPM and unique ID of the BIOS;
the TPM comparing s2′ and s2 and if matched continuing, otherwise signaling an unauthorized action and stopping the boot process;
the TPM signing h1 with the private part of the endorsement key of the TPM—s1″;
the TPM comparing s1″ and s1 and if matched continuing, otherwise signaling an unauthorized action and stopping the boot process;
resuming the pre-boot validation.

25. A computer program product stored on a computer readable medium according to claim 21 for securing a computing device comprising data storage, power-on firmware—BIOS, geolocation and mobile data—GPS/GSM module, and a Trusted Platform Module—TPM, said computer program product comprising program instructions for:
establishing a shared-secret between the BIOS and the TPM, such that the shared-secret proves that the BIOS is authenticated and authorised to use the TPM;
providing an operating system—OS installed on said data storage;
enabling the TPM by the operating system, including setting, or resetting, the Owner Password of the TPM;
the OS requesting the TPM to generate an encryption key for the data storage—KDisk;
the TPM generating the encryption key for the data storage—KDisk;
the TPM encrypting the data storage with KDisk, but not encrypting an OS startup part—MBR of the data storage;
supplying the user of the computing device with KDisk, for external storage;
user optionally providing a password, passphrase or pin from the user, herein referred as a password;
user optionally providing an token device;
the TPM storing indication if the user has provided a password, or if the user has provided a token device, or if has provided both, storing indication if the computing device was reported misplaced or not, with the default value, which corresponds to indicating the computing device has not been misplaced—in TPMflags.
the TPM deterministically deriving a key—KOwner, from the Owner password of the TPM;
the TPM calculating a hash-based message authentication code HMAC—h10 over the BIOS, GPS/GSM module firmware, TPMflags, MBR, unique ID of the TPM, unique ID of the GPS/GSM module, and unique ID of the BIOS using KOwner, with the proviso of KOwner being previous XOR-ed with the user input password if provided;
the TPM calculating a hash-based message authentication code HMAC—h20 over the BIOS, GPS/GSM module firmware, TPMflags, unique ID of the TPM, unique ID of the GPS/GSM module, and unique ID of the BIOS using KOwner, with the proviso of KOwner being previously XOR-ed with the user input password if provided;
the TPM calculating two other hash-based message authentication codes HMAC—h11 and h21, as in h10 and h20, but as if the computing device had been misplaced;
the TPM signing h10, h11, h20 and h21 with the private part of the endorsement key of the TPM—respectively s10, s11, s20 and s21; and storing s10 and s11 in the TPM;
supplying the user of the computing device with h10, s20 and s21, for external storage;
the TPM deterministically deriving and storing a key—Kgsm, from KOwner;
the TPM deterministically deriving a key pair—Ksig,gsm, from KOwner;
the TPM encrypting h10 with Kgsm, signing the encrypted value with the private part of Ksig,gsm and concatenating the encrypted value with the signed value—SMSDATA;
supplying the user of the computing device with a file—FileR comprising the SMSDATA value and the public part of Ksig,gsm, for external storage;
the TPM deterministically deriving a key—KMaster, from h10;
the TPM encrypting KDisk with KMaster;
if the user has provided a token device, storing a first part of the encrypted KDisk in the TPM and storing a second part of the encrypted KDisk in the token device;
if the user has not provided a token device, storing the encrypted KDisk in the TPM;
the TPM disposing of KMaster.

26. A computer program product stored on a computer readable medium according to claim 21 for pre-boot validation for securing a computing device comprising data storage, power-on firmware—BIOS, and a Trusted Platform Module—TPM, said computer program product comprising program instructions for:
having previously established a shared-secret between the BIOS and the TPM, such that the shared-secret proves that the BIOS is authenticated and authorised to use the TPM;
having previously provided an operating system—OS, installed on said data storage;
the TPM retrieving the Owner password of the TPM;
the TPM deterministically deriving a key—KOwner, from the TPM Owner password;
the TPM retrieving a previously stored indication if the user has provided a password, or if the user has provided a token device, or if has provided both—TPMflags;
if the necessary token device or password are not provided, stopping the boot process, otherwise continuing;
the TPM calculating a hash-based message authentication code HMAC—h10′ using KOwner over the BIOS, GPS/GSM module firmware, TPMflags, MBR, unique ID of the TPM, unique ID of the GPS/GSM module, and unique ID of the BIOS, with the proviso of KOwner being previously XOR-ed with the user input password if provided;
the TPM calculating a hash-based message authentication code HMAC—h20′ using KOwner over the BIOS, GPS/GSM module firmware, TPMflags, unique ID of the TPM, unique ID of the GPS/GSM module, and unique ID of the BIOS, with the proviso of KOwner being previously XOR-ed with the user input password if provided;
the TPM calculating two other hash-based message authentication codes HMAC—h11′ and h21′, as in h10′ and h20′, but as if the computing device had been misplaced;
the TPM signing h10′, h11′, h20′ and h21′ with the private part of the endorsement key of the TPM—respectively s10′, s11′, s20′ and s21′;
the TPM retrieving the previously and similarly calculated HMAC codes and previously signed with the private part of the endorsement key of the TPM—s10 and s11;
the TPM comparing s10′ with s10,
i. if matched continuing,
ii. then otherwise, the TPM comparing s11′ with s11,
1. if matched signaling the computing device has been misplaced and stopping the boot process;
2. otherwise signaling a component change for suitable action by the user;
the TPM deterministically deriving a key—KMaster, from h10;
the TPM decrypting the previously stored description key for the data storage—KDisk with KMaster.
the TPM uses KDisk to decrypt the data storage, disposes of KMaster, and allows the OS to start.

27. A computer program product stored on a computer readable medium according to claim 26, further comprising program instructions for, if signalled a component change:
the TPM asking the user to provide the previously calculated and externally stored hash-based message authentication code HMAC—h10, s20, s21 corresponding to h10′, s20′, s21′;
the TPM comparing s20′ and s20 and
i. if matched, continuing,
ii. otherwise, the TPM comparing s21′ and s21 and
1. if matched, signaling the computing device has been misplaced and stopping the boot process,
2. otherwise, signaling an unauthorized action and stopping the boot process;
the TPM signing h10 with the private part of the endorsement key of the TPM—s10″;
the TPM comparing s10″ and s10 and if matched continuing, otherwise signaling an unauthorized action and stopping the boot process;
resuming the pre-boot validation.
